(19) United States
(12) Patent Application Publication
(10) Pub. No.: US 2026/0032398 A1
(43) Pub. Date: Jan. 29, 2026

(54) FLEXIBLE ACOUSTIC SENSOR SYSTEMS AND FABRICATION THEREOF

(71) Applicant: QUALCOMM Incorporated, San Diego, CA (US)

(72) Inventors: Jae Hyeong SEO, Pleasanton, CA (US); Hung-Jen WANG, New Taipei City (TW); Wei-Hsiang WENG, Hsin-Chu (TW); Jessica Liu STROHMANN, Cupertino, CA (US); Shiang-Chi LIN, Taoyuan City (TW); Hrishikesh Vijaykumar PANCHAWAGH, Cupertino, CA (US)

(21) Appl. No.: 19/000,456

(22) Filed: Dec. 23, 2024

Related U.S. Application Data
(60) Provisional application No. 63/676,880, filed on Jul. 29, 2024.

(51) Int. Cl. H04R 31/00; G06F 3/043; G06F 21/32; G06V 40/13; H04R 1/02; H04R 17/02

(52) U.S. Cl. CPC H04R 31/00; G06F 3/0436; G06F 21/32; G06V 40/1306; H04R 1/028; H04R 17/025; G06F 2203/04103; H04R 2499/15

(57) ABSTRACT

Fabrication and processing of flexible acoustic sensor systems and various configurations of sensor stacks associated therewith are disclosed. In some embodiments, a method for fabrication of a flexible acoustic sensing apparatus may include: obtaining a stack of materials on a glass wafer, the stack of materials including: a thin-film transistor (TFT) component having a flexible substrate; a piezoelectric component on the TFT component, the piezoelectric component configured to, responsive to receipt of an acoustic signal, provide an electrical signal to one or more receiver elements having associated circuitry on the TFT component; and an electrode component on the piezoelectric component, the electrode component including one or more acoustic transmitter elements configured to transmit one or more acoustic signals; performing a laser liftoff (LLO) process to separate the stack of materials from the glass wafer; and implementing at least a portion of the stack of materials with a display component.

### CROSS-REFERENCE TO RELATED APPLICATION

This application claims priority under 35 U.S.C. § 119 to U.S. Provisional Application No. 63/676,880, filed on Jul. 29, 2024, the contents of which are hereby incorporated by reference in its entirety for all purposes.

### TECHNICAL FIELD

This disclosure relates generally to devices and systems using acoustic sensing systems.

### DESCRIPTION OF RELATED TECHNOLOGY

A variety of different sensing technologies and algorithms are being implemented in devices. Sensing technology is ubiquitous in devices and can be used in various ways, such as identity and fingerprint detection, and biometric and biomedical applications, including health and wellness monitoring. Biometric authentication via fingerprint sensing is an example of a feature for controlling access to devices or performing other operations. Some such sensing technologies are, or include, acoustic sensors including ultrasonic sensors. Emerging technologies such as flexible devices, including foldable displays, have demanded sensors that are also flexible. Manufacturing processes present a challenge for these emerging types of sensors.

### SUMMARY

The systems, methods and devices of this disclosure each have several aspects, no single one of which is solely responsible for the desirable attributes disclosed herein.

In one aspect of the present disclosure, a method for fabrication of a flexible acoustic sensing apparatus is disclosed. In some embodiments, the method may include: obtaining a thin-film transistor (TFT) device having a flexible substrate; disposing a copolymer material onto the TFT device having the flexible substrate; performing a poling process on the coated copolymer material to produce a piezoelectric layer, wherein the piezoelectric layer is configured to, responsive to receipt of an acoustic signal, provide an electrical signal to one or more receiver elements having associated circuitry of the TFT device; and forming an electrode layer over the piezoelectric layer, the electrode layer including one or more acoustic transmitter elements configured to transmit one or more acoustic signals.

In some implementations thereof, flexible substrate may include polyimide.

In some implementations thereof, the TFT device having the flexible substrate may be disposed on a glass substrate; and the method may further include, subsequent to the forming of the electrode layer over the piezoelectric layer, performing a laser liftoff (LLO) to separate the glass substrate from the TFT device having the flexible substrate.

In some variants thereof, the method may further include applying a first protective layer over the electrode layer prior to the performing of the LLO, the first protective layer including polyethylene terephthalate (PET), polyurethane rubber, or thermoplastic polyurethane (TPU). In some further variants, the method may further include applying a second protective layer to an exposed surface of the TFT device created by the LLO, the second protective layer including PET, polyurethane rubber, or TPU.

In some implementations thereof, the poling process may include a corona poling process in which a corona voltage and a grid voltage are applied for a poling time of 30 minutes at a temperature between 25 and 80 C in dry air.

In some implementations thereof, the obtaining of the TFT device may include adding a buffer layer during fabrication of the TFT device. In some variants thereof, the buffer layer may include silicon dioxide (SiO₂) or silicon nitride (SIN).

In some implementations thereof, the disposing of the copolymer material may include spray coating the copolymer material using a nozzle until a copolymer layer having a thickness of about 5-30 μm is coated on the TFT device. In some implementations, the disposing of the copolymer material may include laminating a copolymer layer on the TFT device.

In some implementations thereof, the flexible acoustic sensing apparatus may be coupled with a control system, the control system configured to: control the one or more acoustic transmitter elements to transmit the one or more acoustic signals toward a target object; receive one or more reflected acoustic signals from the target object; and perform an operation based on the received one or more reflected acoustic signals. In some example approaches, the target object may include a finger of a user; the one or more reflected acoustic signals may include ultrasonic waves corresponding to fingerprint data; and the operation may include a biometric authentication process for the user.

In some embodiments, the method may include: forming a stack of materials on a glass wafer, the stack of materials including: a thin-film transistor (TFT) device having a flexible substrate; a piezoelectric layer on the TFT device, the piezoelectric layer configured to, responsive to receipt of an acoustic signal, provide an electrical signal to one or more receiver elements having associated circuitry on the TFT device; and an electrode layer on the piezoelectric layer, the electrode layer including one or more acoustic transmitter elements configured to transmit one or more acoustic signals; performing a laser liftoff (LLO) process to separate the stack of materials from the glass wafer; subsequent to the LLO process, cutting the stack of materials on the glass wafer into at least one chip having at least a portion of the stack of materials, the at least one chip having one or more dimensions that are smaller than the glass wafer; and implementing the at least one chip having at least the portion of the stack of materials with a display component.

In some implementations thereof, the flexible substrate may include polyimide, and the electrode layer may include a layer of conductive silver ink. In some implementations, the method may further include applying a non-conductive ink on the layer of conductive silver ink.

In some implementations thereof, the method may further include applying a first protective layer over the electrode layer prior to the performing of the LLO, the first protective layer including polyethylene terephthalate (PET), polyurethane rubber, or thermoplastic polyurethane (TPU).

In some implementations thereof, the method may further include: applying a second protective layer to an exposed surface of the TFT device subsequent to the performing of the LLO; and attaching at least the portion of the stack of materials to a flexible printed circuit (FPC) subsequent to the applying of the second protective layer.

In some embodiments, the method may include: obtaining a stack of materials on a glass wafer, the stack of materials including: a thin-film transistor (TFT) component having a flexible substrate; a piezoelectric component on the TFT component, the piezoelectric component configured to, responsive to receipt of an acoustic signal, provide an electrical signal to one or more receiver elements having associated circuitry on the TFT component; and an electrode component on the piezoelectric component, the electrode component including one or more acoustic transmitter elements configured to transmit one or more acoustic signals; performing a laser liftoff (LLO) process to separate the stack of materials from the glass wafer; and implementing at least a portion of the stack of materials with a display component.

In some implementations thereof, the flexible substrate may include polyimide, and the electrode component may include a layer of conductive silver ink. In some implementations, the method may further include applying a non-conductive ink on the layer of conductive silver ink.

In some implementations thereof, the method may further include: applying a second protective layer to an exposed surface of the TFT component subsequent to the performing of the LLO; and attaching at least the portion of the stack of materials to a flexible printed circuit (FPC) subsequent to the applying of the second protective layer.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a block diagram that shows example components of an apparatus according to some embodiments described herein. FIG. 1A shows a block diagram that shows example components of the apparatus of FIG. 1 according to some embodiments.

FIG. 2A shows a block diagram representation of components of an example sensing system.

FIG. 2B shows a block diagram representation of components of an example mobile device that includes the sensing system of FIG. 2A.

FIG. 3A shows a side view of an example configuration of an ultrasonic sensor array capable of ultrasonic imaging.

FIG. 3B shows an example configuration of ultrasonic sensor array.

FIGS. 4A-4C illustrate a flow diagram of an example fabrication process for a flexible acoustic sensor system on a thin-film transistor (TFT) layer, according to some embodiments.

FIG. 5 is a flow diagram of an example process for formation of components of the flexible acoustic sensor system during the example fabrication process of FIGS. 4A-4C, according to some embodiments.

FIG. 6 is a flow diagram of an example process for removal and addition of stabilizing components of the flexible acoustic sensor system during the example fabrication process of FIGS. 4A-4C, according to some embodiments.

FIG. 7 is a flow diagram of an example fabrication process for a flexible acoustic sensor system on a TFT layer using a chip-level laser liftoff (LLO) process, according to some embodiments.

FIG. 8 is a flow diagram of an example fabrication process for a flexible acoustic sensor system on a TFT layer using subplate-level LLO, according to some embodiments.

FIG. 9 is a flow diagram of an example process for manufacturing a flexible acoustic sensor apparatus, according to some embodiments.

FIG. 10 is a cross-sectional diagram of an example stack of materials usable with embodiments of the flexible acoustic sensor system disclosed herein.

FIG. 10A is a cross-sectional diagram of a variation of the example stack of materials usable with embodiments of the flexible acoustic sensor system disclosed herein.

FIG. 11 is a cross-sectional diagram of an example implementation of a sensor stack in a device having a display apparatus.

FIG. 12 shows a flow diagram of an example method for fabrication of a flexible acoustic sensing apparatus, according to some embodiments.

FIG. 13 shows another flow diagram of an example method for fabrication of a flexible acoustic sensing apparatus, according to some embodiments.

Like reference numbers and designations in the various drawings indicate like elements.

### DETAILED DESCRIPTION

The following description is directed to certain implementations for the purposes of describing various aspects of this disclosure. However, a person having ordinary skill in the art will readily recognize that the teachings herein can be applied in a multitude of different ways. Some of the concepts and examples provided in this disclosure are especially applicable to user sensing applications. For example, fingerprint detection can be performed using the disclosed embodiments. However, some implementations also may be applicable to other types of sensing applications including biometric sensing, as well as to various other systems. The described implementations may be implemented in any device, apparatus, or system that includes an apparatus as disclosed herein. In addition, it is contemplated that the described implementations may be included in or associated with a variety of electronic devices (which may also be referred to herein simply as “devices” or a “device”) such as, but not limited to, mobile telephones, multimedia Internet-enabled cellular telephones, mobile television receivers, wireless devices, smartphones, smart cards, tablets, wearable devices such as bracelets, armbands, wristbands, watches, smartwatches, rings, headbands, patches, chest bands, anklets, etc., Bluetooth® devices, personal data assistants (PDAs), wireless electronic mail receivers, handheld or portable computers, netbooks, notebooks, smartbooks, printers, copiers, scanners, facsimile devices, global positioning system (GPS) receivers or navigators, cameras, digital media players, game consoles, wrist watches, clocks, calculators, television monitors, flat panel displays, electronic reading devices (e.g., e-readers), mobile health devices, computer monitors, auto displays (including odometer and speedometer displays, dashboard displays, etc.), cockpit controls and/or displays, camera view displays (such as the display of a rear view camera in a vehicle), architectural structures, microwaves, refrigerators, stereo systems, cassette recorders or players, DVD players, CD players, VCRs, radios, portable memory chips, washers, dryers, washer/dryers, parking meters, automobile doors, Internet of Things (IOT) devices, palm scanners, or point-of-sale (POS) terminals. Thus, the teachings are not intended to be limited to the specific implementations depicted and described with reference to the drawings; rather, the teachings have wide applicability as will be readily apparent to persons having ordinary skill in the art.

Modern devices include various functionalities and hardware that support the functionalities. As but one example, fingerprint sensing using a sensor is one such function of a device. In some embodiments, acoustic imaging, e.g., via transmission and receipt of ultrasonic signals by an acoustic transmitter element and an acoustic receiver element of the fingerprint sensor, may be used to obtain the fingerprint data.

As an aside, toe prints can be used to identify users because they are unique and permanent, similar to fingerprints. Toe prints have ridge (raised portions) patterns and furrows (recessed portions, otherwise known as valleys) similar to fingerprints. Similar to fingerprints, toe prints have unique features referred to as minutiae points that can differentiate one person from another. The whorls, ridges, valleys, and furrows in toe prints develop uniquely in each person. Therefore, the embodiments described herein can be used with toes for equal effectiveness as with fingers. Palms and feet may also be used for identification using unique features. However, toes, palms and feet are used less often for identification, particularly with aforementioned types of devices. For simplicity, “fingerprint” in the context of the present disclosure may refer to fingerprints, toe prints, palm prints, or footprints, and “finger” may refer to fingers, toes, palms, or feet.

Fingerprint sensing can be used by software and applications (apps) usable with a device to biometrically authenticate a user. Fingerprint data obtained using a fingerprint sensor may be used by the device to identify an object (such as a finger or fingerprint), change an operative state of the device, and/or perform other operations with the device (unlock or lock the device, initialize an application, authenticate a user, etc.). Some devices may be configured such that the sensor (such as a fingerprint sensor) is disposed beneath a display or other surface, which in cases of some devices (smartphone, tablets, etc.) may be a screen or other user interface.

Fingerprint sensors are thus useful for various purposes and are usable with various types of devices and/or displays. However, there are performance limitations when it comes to certain devices. As one example, flexible or foldable devices, when using typical sensors do not have the level of sensing performance that can be seen with, e.g., flat-panel displays. As a more specific example, ultrasonic signals transmitted or received by conventional sensors in conventional foldable displays or display stacks may have a transmission rate or a signal strength that is as little as 25-35% of that of an OLED (organic light-emitting diode) panel or a plastic OLED (POLED). As acoustic sensing often uses plane-wave propagation, weak signals are a challenge especially in fingerprint sensing with flexible (e.g., foldable) devices. As consumer devices and display technologies continue to mature, and flexible displays become more applicable in existing and emerging technologies, improving the performance of sensors in such flexible devices (which may include or utilize curved surfaces or displays or screens) can improve user experience and allow the sensors to be used with many types of devices and other objects.

Various an acoustic (e.g., ultrasonic) sensor apparatus or system may include a stack of materials comprising a sensor element and other components that enable propagation and detection of acoustic signals. The sensor apparatus may have physically flexible and pliable properties so as to allow the sensor apparatus to conform to a non-planar surface, such as a curved or rounded surface, or a surface that can be deformed to be curved or rounded along at least one axis. For example, the sensor apparatus may be used with a foldable device or a device having a curved surface or platen. The sensor stack may include materials to enable the flexibility and pliability of the sensor apparatus, such as a flexible substrate composed of polyimide in some embodiments, or other types of polymers in other embodiments, ultra-thin glass (UTG) as a platen or a portion thereof, etc. Further, the sensor stack may include a layer of one or more pixelated receiver electrode elements of a thin-film transistor (TFT) circuitry grown on a flexible substrate, a piezoelectric layer comprising a copolymer adjacent to the TFT layer, and one or more transmitting elements of an electrode layer adjacent to the piezoelectric layer. In some implementations, the electrode layer may receive transmit signals that cause emission of acoustic (e.g., ultrasonic) waves toward a target object of interest (e.g., a finger at a surface of a platen on the other side of the flexible substrate). The one or more acoustic receiver pixels (of the TFT circuitry) may receive electric signals generated from the piezoelectric copolymer layer that receives acoustic (e.g., ultrasonic) waves reflected from the object of interest. In some embodiments, the sensor stack may be embedded within a display apparatus, such as underneath a cover glass or platen and a light-emitting (e.g., OLED) layer, but above a backplate of the display apparatus.

However, it is difficult to process a thin layer of TFT circuitry and polyimide (among other layers) during fabrication because the layers are soft by nature of their flexibility and pliability. The layers are not sufficiently rigid and may not stay together or in place. To these ends, approaches to fabrication processes for the aforementioned flexible acoustic sensor apparatus are disclosed to overcome processing challenges and achieve improved sensor performance.

In some approaches, a TFT device having a flexible substrate (e.g., polyimide) on a glass substrate may be obtained, on which a copolymer material may be coated (e.g., using a nozzle) to form a copolymer layer having piezoelectric properties. In some embodiments, one or more annealing processes may be performed, including a soft bake (e.g., to control the thickness and the roughness of the copolymer layer) and/or a crystallization process (e.g., to align dipoles within the polymer chains to produce a net polarization and allow the copolymer layer to maintain its piezoelectric properties and mechanical and thermal stability). Further, a poling process may be performed on the coated copolymer material to align the dipoles and produce a (polarized) piezoelectric layer. Thereafter, further layers, such as an electrode layer and/or a layer of ink, may be disposed over the piezoelectric layer to produce a stack of materials. The electrode layer may be configured to transmit acoustic signals toward a target object (e.g., a finger of a user), and the TFT device may include one or more pixelated receiver electrodes having associated TFT circuitry, configured to perform functions of acoustic receiver elements such as detection of acoustic signals (in conjunction with the piezoelectric layer). In some embodiments, a laser liftoff (LLO) process may be performed to separate the stack of materials from the glass substrate. One or more protective layers may be applied to the resulting flexible sensor stack, which may be susceptible to contamination or mechanical stresses without the glass substrate, e.g., for handling and/or further processing. For example, the flexible sensor stack may be used with a curved surface or a flexible device, such as a foldable display, e.g., after removing the protective layers.

In some approaches, the LLO process may be performed at a “subplate level,” while in other approaches, LLO may be done on a “chip level.” A subplate-level LLO may be performed on a large glass substrate or wafer, rather than a portion of the glass wafer (e.g., chips or dice resulting after cutting).

Particular implementations of the subject matter described in this disclosure can be implemented to realize one or more of the following potential advantages. Flexible sensors apparatus may enable acoustic sensors to be utilized in various types of surfaces (e.g., curved or distorted surfaces) and/or devices (e.g., foldable displays) by using a flexible sensor stack, while maintaining reliability and achieving high resolution under display with a very thin stack. Advantageously, flexible sensor stacks may be kept cohesive and protected by using protective layers or films when separated from a rigid (e.g., glass) substrate, e.g., using LLO. Despite susceptibility of flexible stacks to mechanical stresses, processing and handling may be made easier, including downstream lamination to or embedding inside a display device. In some cases, some steps may be omitted from conventional flexible stack processing methods. For example, there may not be a thinning process or certain dehydrogenation steps, and hence, the cost associated with the fabrication process may be lower.

Additional details will follow after an initial description of relevant systems and technologies.

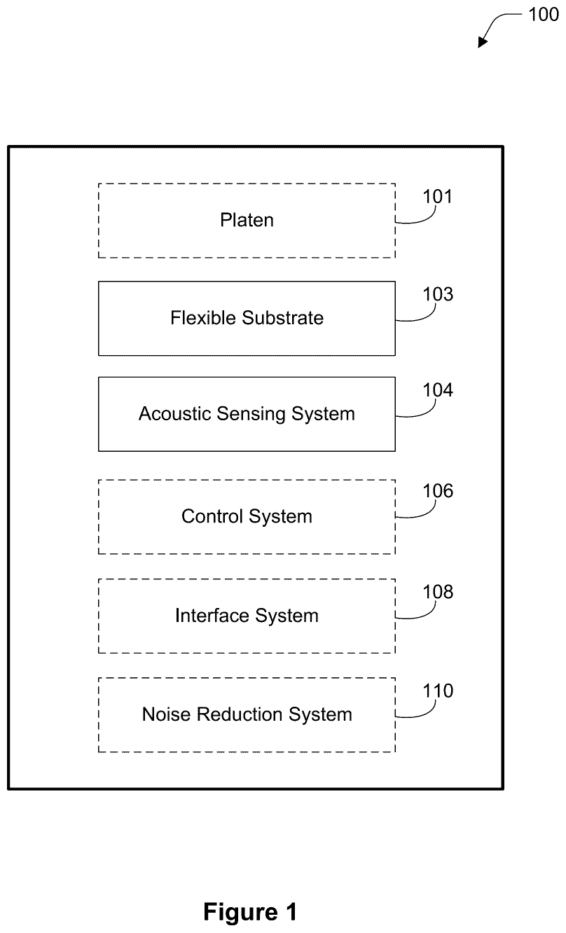

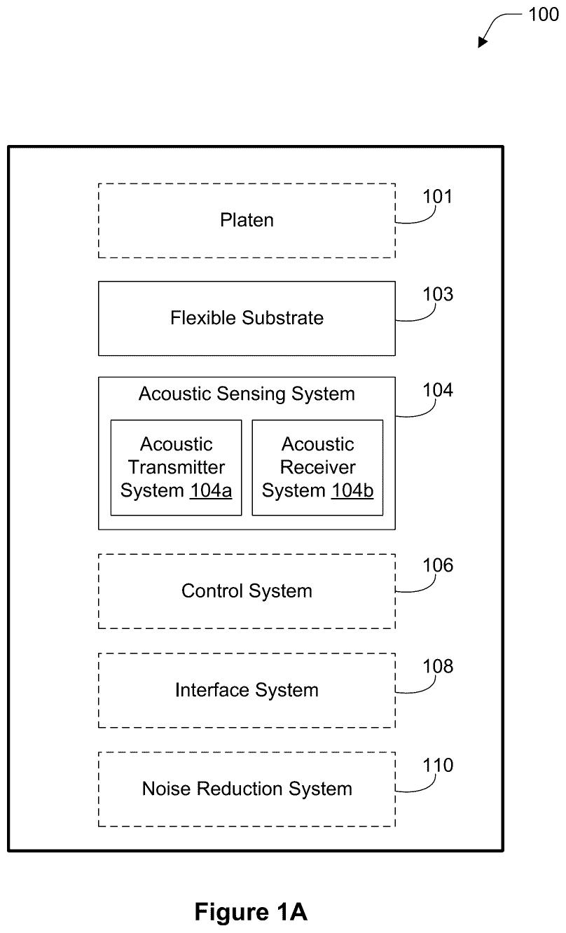

FIG. 1 is a block diagram that shows example components of an apparatus 100 according to some implementations. In some example embodiments, the apparatus 100 may include a flexible substrate 103 and an acoustic sensing system 104.

Some implementations of the apparatus 100 may include a control system 106, an interface system 108, a noise reduction system 110, or a combination thereof.

In some configurations, apparatus 100 may be a sensor, sensor apparatus, or a sensing system usable with an electronic device such as that listed elsewhere above. In some configurations, apparatus 100 may be part of the device or another apparatus.

In some applications, platen 101 may be included with the apparatus 100 or separate from the apparatus 100. Platen 101 may be or include a surface of a device. Some examples of a platen 101 may be part of, or include, a display apparatus, such as an OLED panel or another flat-panel display, or a flexible display, or a layer of a stack of materials of a display apparatus. The platen 101 may at least partly include a visually and/or optically transparent portion.

While platens generally have rigid and inflexible surfaces, the platen 101 disclosed herein may not be so rigid (or may be rigid in some cases, e.g., glass panel). In various implementations, platen 101 may include a surface that is capable of bending, folding, or other distortions, or it may be fixed at, or as, a curved surface. To achieve this flexibility, platen 101 may be composed of a polymer such as polyethylene, parylene, polystyrene, polyurethane rubber, or another flexible material. In further examples, the platen 101 may be a surface of an object such as the handle of a steering wheel of a vehicle (which typically has a curved geometry similar to a torus), a curved edge of a touchscreen, a surface of a mobile device such the side of a headset, a surface of a controller such as a handheld and/or wireless controller for controlling or interacting with extended reality (XR) (including virtual reality (VR), augmented reality (AR), mixed reality (MR), a wristwatch or wristband, a doorknob or handle, a pole or pole-shaped object or device, a wall, an electronic device listed above, or other surfaces of an object or device that may be communicatively and/or physically coupled with an electronic device or other computerized apparatus.

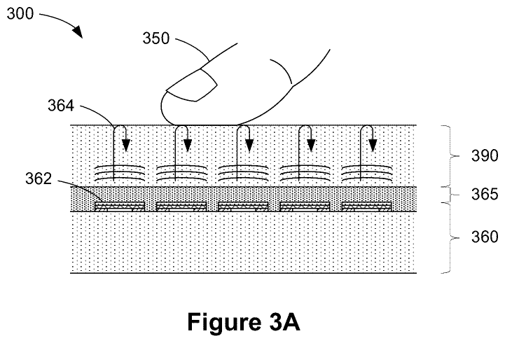

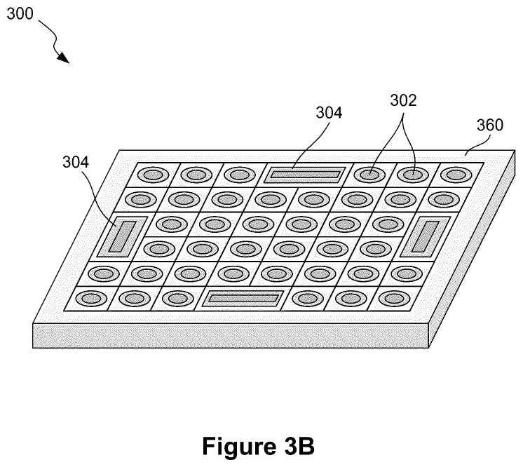

The platen 101 may be constructed such that a portion or a body part of a user (e.g., a finger) can be received by and make contact with the platen 101. In some applications, at least a portion of the platen 101 may be associated with a sensing portion or a sensing area, where acoustic (e.g., ultrasonic) sensing may occur with an object such as a portion or body part of a user (e.g., a finger). Further features of the platen 101 relating to transmission of acoustic signals and receipt of acoustic signals reflected from the portion of the user will be described with respect to platen 390 in FIG. 3A.

As will be described further below, the flexible substrate 103 (and/or other components of the apparatus 100 or the associated stack of materials) may give the apparatus 100 the capability to be curved to conform to any shape, such as the shape of the platen 101 or other desired shape. For instance, during the bending, folding, or twisting of a device implementing the apparatus 100, the apparatus 100 may also be bent, folded, or twisted. As alluded to above, the apparatus 100 may alternatively be fixed to a bent, folded, twisted, or otherwise curved surface.

In some embodiments, the flexible substrate 103 may be disposed adjacent to an acoustic sensing system 104. In some embodiments, an acoustic sensing system 104 may include, e.g., an acoustic transmitter system and an acoustic receiver system, embodiments and implementations of which are described below. The flexible substrate 103 can be conformed to a curved surface (and indeed any shape) because it may be constructed of a flexible material, and thereby allow the apparatus 100 to conform to a curved shape (or deform, e.g., fold or bend). In some implementations, flexible substrate 103 may be a polymer such as polyimide. In other implementations, flexible substrate 103 may be constructed of polyethylene terephthalate (PET), polyethylene naphthalate (PEN), thermoplastic polyurethane (TPU), cellulose paper, polyestersulfone (PES), or colorless polyimide (CPI). In some implementations, flexible substrate 103 may be constructed of stainless steel.

In varying implementations, the flexible substrate 103 may have a thickness of 5 to 50 microns (μm). Depending on the use case or application, the flexible substrate 103 may have a thickness that is lower or higher than the foregoing range, or on the lower end or the higher end of the foregoing range, to support the desired amount of flexibility. As an illustrative consideration, the flexible substrate 103 may be closer to 10-20 μm thick if more flexibility is desired, e.g., where the apparatus 100 is used with a highly curved surface, or used with a device that folds frequently such as a foldable display. On the other hand, the flexible substrate 103 may be closer to 40-50 μm thick if less flexibility is needed, e.g., where the apparatus 100 is disposed at a substantially planar surface with little curvature. In the case of stainless steel, the thickness may be thinner, e.g., 10-25 μm.

Various configurations of an acoustic transmitter system 104a and an acoustic receiver system 104b are also disclosed herein. As indicated above and in FIG. 1A, acoustic transmitter system 104a and acoustic receiver system 104b may be collectively included in an acoustic sensing element, or the acoustic sensing system 104. For example, acoustic transmitter system 104a and acoustic receiver system 104b may share the same piezoelectric copolymer layer of a stack of materials associated with the apparatus 100. Specific examples of the acoustic transmitter system 104a and the acoustic receiver system 104b are described in more detail below.

In some embodiments, the acoustic transmitter system 104a may be configured to generate and emit acoustic signals, e.g., toward a target object, such as a finger or other object. Acoustic signals may include one or more acoustic waves, such as, in some scenarios, ultrasonic waves 364 as shown in FIG. 3A. In some implementations, the acoustic transmitter system 104a may include one or more ultrasonic transmitters or transmitter elements configured to generate, emit, and/or direct ultrasonic waves. The one or more ultrasonic transmitters may be one or more ultrasonic transducers. In some implementations, ultrasonic waves may be generated in a selected portion of multiple ultrasound transmitter elements (e.g., in an array). In some configurations, the one or more ultrasonic transmitter elements may be arranged in an array of ultrasonic transducer elements, such as an array of PMUTs and/or an array of CMUTs. In some examples, the ultrasonic transmitter(s) may include an ultrasonic plane-wave generator.

In some implementations, a control system 106 may include one or more controllers or processors, or a drive circuit or various types of drive circuitry, configured to control the one or more ultrasonic transmitter elements via one or more instructions to the acoustic transmitter system 104a. For example, ultrasonic waves may be generated in pulses (e.g., at least partly repeating or other patterns) or according to other timing instructions. Although “ultrasound” may typically apply to acoustic energy with a frequency above human hearing, or 20 kilohertz (kHz), ultrasound frequencies used for fingerprint imaging may exceed well over this lower limit. In some implementations, the control system 106 may cause ultrasonic waves from the acoustic transmitter system 104a to be generated and emitted at a frequency that is between about 12 megahertz (MHz) to 50 MHz, which may result in sufficient resolution for fingerprint imaging, e.g., up to 1000 dots per inch (dpi). Other suitable frequencies may be used for the acoustic waves in other implementations.

Control system 106 may be electrically and/or communicatively coupled to the apparatus 100. In some configurations, the control system 106 may be part of the apparatus 100. In some configurations, the control system 106 may be part of a device having the apparatus 100. In some configurations, the control system 106 may be external to the apparatus 100 or the device having the apparatus 100, for example but not limited to, on a server (cloud), remote storage, or another device other than the device having the apparatus 100. In some configurations, the one or more controllers or processors of the control system 106 may be distributed across two or more devices including external apparatus.

In some implementations, the control system 106 may include one or more general purpose single-or multi-chip processors, digital signal processors (DSPs), application-specific integrated circuits (ASICs), field programmable gate arrays (FPGAs) or other programmable logic devices, discrete gates or transistor logic, discrete hardware components, or combinations thereof. The control system 106 also may include (and/or be configured for communication with) one or more memory devices, such as one or more random access memory (RAM) devices, read-only memory (ROM) devices, etc. Accordingly, the apparatus 100 may have a memory system that includes one or more memory devices, though the memory system is not shown in FIG. 1. In some implementations, functionality of the control system 106 may be partitioned between one or more controllers or processors, such as a dedicated sensor controller and an applications processor of a mobile device.

If the apparatus 100 includes an ultrasonic transmitter, such as in the acoustic transmitter system 104a, the control system 106 may be configured for controlling the ultrasonic transmitter. In some embodiments, a control system 106 may cause the acoustic transmitter system 104a to generate and emit acoustic waves. In some implementations, the control system 106 may cause the acoustic transmitter system 104a to generate and emit acoustic waves in response to a detection of an object (e.g., a finger). In some cases, the object may be detected based at least on a force applied to the apparatus 100. Sensor elements 304 may be used for non-ultrasonic force detection, for example. In another example, a resistive sensor or capacitive sensing with a touchscreen may allow detection of sufficient force applied to the apparatus 100.

In some cases, the object may be detected based at least on light occlusion. In such cases, a light sensor may also be included with the apparatus 100 so that an amount of light or its absence (e.g., relative to a threshold) can be determined, e.g., by control system 106, at or near the apparatus 100.

In some cases, the object may be detected based at least on a capacitive shift or response. For example, a capacitive sensor or touchscreen may allow determination of a capacitive response based on the natural conductivity of the object such as a finger that is making contact with the platen 101 of the apparatus 100.

In some implementations, a combination of one or more detection methods described above may be used to detect the object. For instance, detection of the object may require, in some configurations, sufficient force and sufficient capacitive response. In another example, detection of the object may require sufficient force, sufficient capacitive response, and sufficient absence of light.

In some configurations, a delay may be placed between the detection of the object and the emission of the acoustic waves, where the length of the delay may be 100 milliseconds, 500 milliseconds, etc. Not causing emission of acoustic waves immediately may allow time for the object to stabilize against the apparatus 100 before performing, e.g., fingerprint sensing. Force or occlusion may occur even if the finger is not pressed onto the apparatus 100 completely.

In some implementations, the acoustic transmitter system 104a may include one or more acoustic waveguides or ultrasonic waveguides (or other sound-directing elements) constructed to propagate and direct acoustic or ultrasonic waves toward a target location that does not have direct line of sight from at least a portion of the one or more ultrasound transmitter elements. Such waveguides may be useful in certain devices, e.g., foldable displays, or chasses that may optimize the locations of the acoustic transmitter system 104a and the location of a fingerprint sensor by placing them out of direct line of sight.

The acoustic signals (e.g., ultrasonic waves) emitted from acoustic transmitter system 104a may cause or result in reflection of acoustic wave emissions at least in part from the object (e.g., finger). As noted above, characteristics of the reflected waves such as amplitudes may depend in part on the acoustic properties of the object and/or the platen. These reflected acoustic waves (e.g., ultrasonic waves) may be detectable by the acoustic receiver system 104b.

Various examples of an acoustic receiver system 104b are disclosed herein, some of which may include an ultrasonic receiver system. In some implementations, the acoustic receiver system 104b may include an ultrasonic receiver system having the one or more ultrasonic receiver elements. In some implementations, one or more discrete portions, or one or more pixelated receiver electrodes, may form at least part of corresponding one or more acoustic receiver elements represented by one or more receiver pixels, each of which forms part of thin-film transistor (TFT) circuitry. In some implementations, one or more ultrasonic receiver elements and one or more ultrasonic transmitter elements may be combined in an ultrasonic transceiver. In some examples, the acoustic receiver system 104b and the acoustic transmitter system 104a may both include the same piezoelectric receiver layer, such as a layer of polyvinylidene fluoride (PVDF) polymer or a layer of poly (vinylidene fluoride-co-trifluoroethylene) (PVDF-TrFE) copolymer. In some implementations, a single piezoelectric layer may serve as an ultrasonic receiver. In some implementations, other piezoelectric materials may be used in the piezoelectric layer, such as aluminum nitride (AIN) or lead zirconate titanate (PZT). According to some examples, the acoustic receiver system 104b may be, or may include, an ultrasonic receiver array. The acoustic receiver system 104b may, in some examples, include an array of ultrasonic transducer elements, such as an array of PMUTs, an array of CMUTs, etc. In some such examples, a piezoelectric receiver layer, PMUT elements in a single-layer array of PMUTs, or CMUT elements in a single-layer array of CMUTs, may be used as ultrasonic transmitters (such as those that are included in acoustic transmitter system 104a ) as well as ultrasonic receivers. In some examples, the apparatus 100 may include one or more separate ultrasonic transmitter elements or one or more separate arrays of ultrasonic transmitter elements. Ultrasonic sensor array 300, sensor system 202, and ultrasonic sensor array 212 may be examples or implementations of the acoustic receiver system 104b.

In the context of the present disclosure, a transmitter element and a receiver element may collectively or individually be referred to as a “sensing element,” an “acoustic sensing element,” a “sensor element,” or an “acoustic sensor element.” Such an element may also refer to a transceiver element or an acoustic transceiver element. In some instances, the foregoing terms may refer collectively, for example as a sensing element, to a transmitter element and a receiver element that share the same piezoelectric layer.

In some other embodiments, the acoustic receiver system 104b may include one or more microphones configured to detect acoustic signals. Each microphone may be a MEMS (micro-electromechanical system) microphone having an inlet port, a cavity, and/or a membrane or mesh to facilitate detection and receipt of acoustic signals, e.g., sound waves. In some implementations, the microphone(s) may be part of another apparatus or system other than the apparatus 100, such as the interface system 108 described below.

Accordingly, embodiments of apparatus 100 may be configured to operate as ultrasound sensors that are configured to receive reflected acoustic signals such as ultrasonic waves. Reflected ultrasonic waves may include scattered waves, specularly reflected waves, or both scattered waves and specularly reflected waves. The reflected waves can provide acoustic data, including information about the object, e.g., a finger's ridges and valleys and their shapes and patterns.

More specifically, in some embodiments, control system 106 may be configured to receive the acoustic data (e.g., from acoustic receiver system 104b ) and/or generate images (e.g., three-dimensional images) representative of the object such as a finger. That is, fingerprint imaging may be performed using the acoustic data received by the acoustic receiver system 104b. Images may be matched to a reference to identify the fingerprint image.

In some examples, the control system 106 may be communicatively coupled to a light source system (not shown) and configured to control the light source system to emit light towards a target object (such as a finger) on an outer surface of the platen 101. In some such examples, the control system 106 may be communicatively coupled to and configured to receive signals from the acoustic receiver system 104b (including one or more receiver elements, such as sensor elements 362) corresponding to the ultrasonic waves generated by the target object responsive to the light from the light source system.

In the context of fingerprint sensing, ultrasonic fingerprint sensing may advantageously be more reliable and secure (e.g., for storing user identifying information), and have a smaller and more flexible footprint, than other types of fingerprint sensing such as traditional optical fingerprint scanning that relies on optical imaging.

Some implementations of the apparatus 100 may include an interface system 108. In some examples, the interface system 108 may include a wireless interface system. In some implementations, the interface system 108 may include a user interface system, one or more network interfaces, one or more communication interfaces between the control system 106 and a memory system and/or one or more interfaces between the control system 106 and one or more external device interfaces (such as ports or applications processors), or combinations thereof. According to some examples in which the interface system 108 is present and includes a user interface system, the user interface system may include a microphone system (including, e.g., one or more microphones), a loudspeaker system, a haptic feedback system, a voice command system, one or more displays, or combinations thereof. According to some examples, the interface system 108 may include a touch sensor system, a gesture sensor system, or a combination thereof. The touch sensor system (if present) may be, or may include, a resistive touch sensor system, a surface capacitive touch sensor system, a projected capacitive touch sensor system, a surface acoustic wave touch sensor system, an infrared touch sensor system, any other suitable type of touch sensor system, or combinations thereof.

In some examples, the interface system 108 may include a force sensor system. The force sensor system (if present) may be, or may include, a piezo-resistive sensor, a capacitive sensor, a thin film sensor (for example, a polymer-based thin film sensor), another type of suitable force sensor, or combinations thereof. If the force sensor system includes a piezo-resistive sensor, the piezo-resistive sensor may include silicon, metal, polysilicon, glass, or combinations thereof. An ultrasonic fingerprint sensor and a force sensor system may, in some implementations, be mechanically coupled. In some implementations, the force sensor system may be mechanically coupled to a platen. In some such examples, the force sensor system may be integrated into circuitry of the ultrasonic fingerprint sensor. In some examples, the interface system 108 may include an optical sensor system, one or more cameras, or a combination thereof.

According to some examples, the apparatus 100 may include a noise reduction system 110. In some implementations, the noise reduction system 110 may include one or more sound-absorbing layers, acoustic isolation material, or combinations thereof. In some examples, the noise reduction system 110 may include acoustic isolation material, which may reside between at least a portion of the acoustic transmitter system 104a and at least a portion of the acoustic receiver system 104b, e.g., between ultrasonic transmitter elements and ultrasonic receiver elements. In some examples, the noise reduction system 110 may include one or more electromagnetically shielded transmission wires. In some such examples, the one or more electromagnetically shielded transmission wires may be configured to reduce electromagnetic interference from circuitry of the acoustic transmitter system 104a, circuitry of the acoustic receiver system 104b, or combinations thereof, that is received by the acoustic receiver system 104b.

In some implementations, the apparatus 100 may be part of a mobile device. In some implementations, the apparatus 100 may be part of a wearable device configured to be worn by a user, such as around the wrist, finger, arm, leg, ankle, or another appendage, or another portion of the body. In an example implementation, the wearable device may have the form of a wristwatch and can be worn around the wrist.

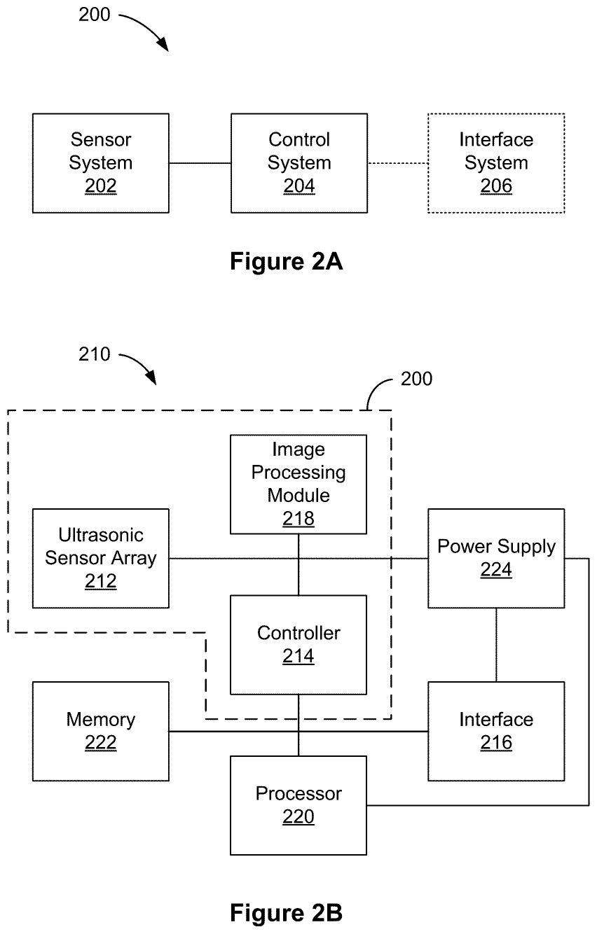

An ultrasonic sensor array may be part of a sensing system of a device, for example, apparatus 100 implemented with a mobile device. FIG. 2A shows a block diagram representation of components of an example sensing system 200. As shown, the sensing system 200 may include a sensor system 202 and a control system 204 that may, in some implementations, be electrically and/or communicatively coupled to the sensor system 202. In some implementations, control system 204 may include one or more controllers or processors. Control system 204 may be an example of control system 106. In some configurations, the control system 204 may be part of the device having the sensing system. In some configurations, the control system 204 may be part of the sensing system. In some configurations, the control system 204 may be external to the device having the sensing system, for example but not limited to, on a server (cloud), remote storage, or another device other than the device having the sensing system. In some configurations, the one or more controllers or processors may be distributed across two or more devices including external apparatus.

In some examples, the sensor system 202 may include at least the acoustic sensing system 104. In some examples, the sensor system 202 may include at least the flexible substrate 103 and the acoustic sensing system 104. The sensor system 202 (e.g., in conjunction with control system 204, in some implementations) may be capable of detecting the presence of an object, for example a human finger. The sensor system 202 may be capable of scanning an object and providing raw measured image information usable to obtain an object signature, for example, a fingerprint of a human finger (such as 350). The control system 204 may be capable of controlling the sensor system 202 and processing the raw measured image information received from the sensor system. In some implementations, the sensing system 200 may include an interface system 206 capable of transmitting or receiving data, such as raw or processed measured image information, to or from various components within or integrated with the sensing system 200 or, in some implementations, to or from various components, devices or other systems external to the sensing system.

FIG. 2B shows a block diagram representation of components of an example mobile device 210 that includes the sensing system 200 of FIG. 2A. The sensor system 202 of the sensing system 200 of the mobile device 210 may be implemented with an ultrasonic sensor array 212, such as the ultrasonic sensor array 300 shown in FIG. 3B. The control system 204 of the sensing system 200 may be implemented with a controller 214 that is electrically coupled to the ultrasonic sensor array 212. While the controller 214 is shown and described as a single component, in some implementations, the controller 214 may collectively refer to two or more distinct control units or processing units in electrical communication with one another. In some implementations, the controller 214 may include one or more of a general purpose single-or multi-chip processor, a central processing unit (CPU), a digital signal processor (DSP), an applications processor, an application specific integrated circuit (ASIC), a field programmable gate array (FPGA) or other programmable logic device (PLD), discrete gate or transistor logic, discrete hardware components, or any combination thereof designed to perform the functions and operations described herein.

The sensing system 200 of FIG. 2B may include an image processing module 218. In some implementations, raw measured image information provided by the ultrasonic sensor array 212 may be sent, transmitted, communicated or otherwise provided to the image processing module 218. The image processing module 218 may include any suitable combination of hardware, firmware and software configured, adapted or otherwise operable to process the image information provided by the ultrasonic sensor array 212. In some implementations, the image processing module 218 may include signal or image processing circuits or circuit components including, for example, amplifiers (such as instrumentation amplifiers or buffer amplifiers), analog or digital mixers or multipliers, switches, analog-to-digital converters (ADCs), passive or active analog filters, among others. In some implementations, one or more of such circuits or circuit components may be integrated within the controller 214, for example, where the controller 214 is implemented as a system-on-chip (SoC) or a system-in-package (SIP). In some implementations, one or more of such circuits or circuit components may be integrated within a DSP included within or coupled to the controller 214. In some implementations, the image processing module 218 may be implemented at least partially via software. For example, one or more functions of, or operations performed by, one or more of the circuits or circuit components just described may instead be performed by one or more software modules executing, for example, in a processing unit of the controller 214 (such as in a general purpose processor or a DSP).

In some implementations, in addition to the sensing system 200, the mobile device 210 may include a separate processor 220 such as an applications processor, a memory 222, an interface 216 and a power supply 224. In some implementations, the controller 214 of the sensing system 200 may control the ultrasonic sensor array 212 and the image processing module 218, and the processor 220 of the mobile device 210 may control other components of the mobile device 210. In some implementations, the processor 220 may communicate data to the controller 214 including, for example, instructions or commands. In some such implementations, the controller 214 may communicate data to the processor 220 including, for example, raw or processed image information. It should also be understood that, in some other implementations, the functionality of the controller 214 may be implemented entirely, or at least partially, by the processor 220. In some such implementations, a separate controller 214 for the sensing system 200 may not be required because the functions of the controller 214 may be performed by the processor 220 of the mobile device 210.

Depending on the implementation, one or both of the controller 214 and processor 220 may store data in the memory 222. For example, the data stored in the memory 222 may include raw measured image information, filtered or otherwise processed image information, estimated PSF or estimated image information, and final refined PSF or final refined image information. The memory 222 may store processor-executable code or other executable computer-readable instructions capable of execution by one or both of the controller 214 and the processor 220 to perform various operations (or to cause other components such as the ultrasonic sensor array 212, the image processing module 218, or other modules to perform operations), including any of the calculations, computations, estimations or other determinations described herein (including those presented in any of the equations below). It should also be understood that the memory 222 may collectively refer to one or more memory devices (or “components”). For example, depending on the implementation, the controller 214 may have access to and store data in a different memory device than the processor 220. In some implementations, one or more of the memory components may be implemented as a NOR-or NAND-based Flash memory array. In some other implementations, one or more of the memory components may be implemented as a different type of non-volatile memory. Additionally, in some implementations, one or more of the memory components may include a volatile memory array such as, for example, a type of RAM.

In some implementations, the controller 214 or the processor 220 may communicate data stored in the memory 222 or data received directly from the image processing module 218 through an interface 216. For example, such communicated data can include image information or data derived or otherwise determined from image information. The interface 216 may collectively refer to one or more interfaces of one or more various types. In some implementations, the interface 216 may include a memory interface for receiving data from or storing data to an external memory such as a removable memory device. Additionally or alternatively, the interface 216 may include one or more wireless network interfaces or one or more wired network interfaces enabling the transfer of raw or processed data to, as well as the reception of data from, an external computing device, system or server.

A power supply 224 may provide power to some or all of the components in the mobile device 210. The power supply 224 may include one or more of a variety of energy storage devices. For example, the power supply 224 may include a rechargeable battery, such as a nickel-cadmium battery or a lithium-ion battery. Additionally or alternatively, the power supply 224 may include one or more supercapacitors. In some implementations, the power supply 224 may be chargeable (or “rechargeable”) using power accessed from, for example, a wall socket (or “outlet”) or a photovoltaic device (or “solar cell” or “solar cell array”) integrated with the mobile device 210. Additionally or alternatively, the power supply 224 may be wirelessly chargeable.

As used herein, the term “processing unit” refers to any combination of one or more of a controller of an ultrasonic system (for example, the controller 214), an image processing module (for example, the image processing module 218), or a separate processor of a device that includes the ultrasonic system (for example, the processor 220). In other words, operations that are described below as being performed by or using a processing unit may be performed by one or more of a controller of the ultrasonic system, an image processing module, or a separate processor of a device that includes the sensing system.

FIG. 3A illustrates a side view of an example configuration of an ultrasonic sensor array of sensor elements which is capable of ultrasonic imaging. FIG. 3A depicts an ultrasonic sensor array 300 with an array of sensor elements configured as transmitting and receiving elements that may be used for ultrasonic imaging. In some implementations, the ultrasonic sensor array 300 may be an example of or a portion of a sensor element or a sensor as discussed herein.

Sensor elements 362 on a sensor array substrate 360 may emit and detect ultrasonic waves. In some implementations, sensor array substrate 360 may be an example of the flexible substrate 103 discussed above, and may thus be flexible (e.g., foldable). As illustrated, an ultrasonic wave 364 may be transmitted from at one or more sensor elements 362. The ultrasonic wave 364 may travel through a propagation medium such as an acoustic coupling medium 365 and a platen 390 towards an object 350 such as a finger or a stylus positioned on an outer surface of the platen 390. Platen 390 may be an example of platen 101, and may thus be flexible (e.g., foldable) in some implementations. A portion of the ultrasonic wave 364 may be transmitted through the platen 390 and into the object 350, while a second portion is reflected from the surface of platen 390 back towards a sensor element 362. The amplitude of the reflected wave may depend in part on the acoustic properties of the object 350 and the platen 390. The reflected wave may be detected by the sensor elements 362, from which an image of the object 350 may be acquired. For example, with sensor arrays having a pitch of about 50 microns (about 500 pixels per inch), ridges and valleys of a fingerprint may be detected. An acoustic coupling medium 365, such as an adhesive, gel, a compliant layer or other acoustic coupling material may be provided to improve coupling between an array of sensor elements 362 disposed on the sensor array substrate 360 and the platen 390. The acoustic coupling medium 365 may aid in the transmission of ultrasonic waves to and from the sensor elements 362. The platen 390 may include, for example, a layer of glass, plastic, sapphire, metal, metal alloy, or other platen material. An acoustic impedance matching layer (not shown) may be disposed on an outer surface of the platen 390. The platen 390 may include a coating (not shown) on the outer surface. In some implementations, sensor elements may be co-fabricated with thin-film transistor (TFT) circuitry or CMOS circuitry on or in the same substrate, which may be a silicon, silicon on insulator (SOI), glass or plastic substrate, in some examples. The TFT, silicon or semiconductor substrate may include row and column addressing electronics, multiplexers, local amplification stages and control circuitry.

FIG. 3B shows an example configuration of an ultrasonic sensor array including sensor elements 302 and sensor elements 304 formed on a substrate 360. Substrate 360 may be an example of the sensor array substrate 360 mentioned above. The sensor elements 302 are shown as circular sensor elements. In some implementations, the sensor elements 302 are not used for force detection in the non-ultrasonic force detection mode. Sensor elements 304 are larger than the sensor elements 302 and are shown as rectangular. It will be understood that these sensor elements 302, 304 may be any appropriate shape and size. In some implementations, the sensor elements 304 that are used for non-ultrasonic force detection may be larger than the sensor elements 302 that are used solely for ultrasonic imaging. The sensor elements 304, used during non-ultrasonic force detection mode to detect applied force as described above, are located on the periphery of the ultrasonic sensor array 300. By placing the sensor elements 304 used for force detection around the periphery, the ultrasonic sensor array may be used for centering detection. While only the sensor elements 304 are used for non-ultrasonic force detection, both sensor elements 302 and sensor elements 304 may be used for ultrasonic imaging as described above with respect to FIG. 3A. That is, the sensor elements 304 may initially be used to statically detect force from a finger press and then be switched to an ultrasonic mode for ultrasonic imaging in some implementations. In alternative implementations, the sensor elements 304 may be used only for force detection, with only the sensor elements 302 used for ultrasonic imaging. In some implementations, sensor elements 304 near the periphery of the ultrasonic sensor array 300 may be used for cursor, pointer or icon control, or for screen navigation on a display of a mobile device. In some implementations, some or all of sensor elements 302, 304, 362 in FIGS. 3A and 3B may be piezoelectric micromachined ultrasonic transducers (PMUT) and/or capacitive micromachined ultrasonic transducers (CMUT) sensor elements.

### Example Flexible Sensor Fabrication Processes

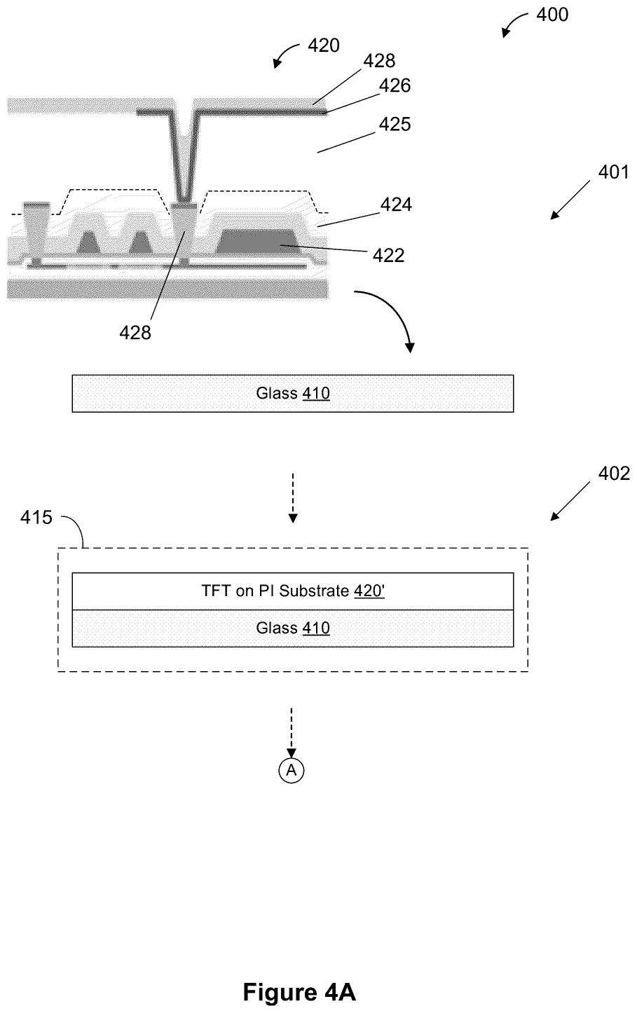

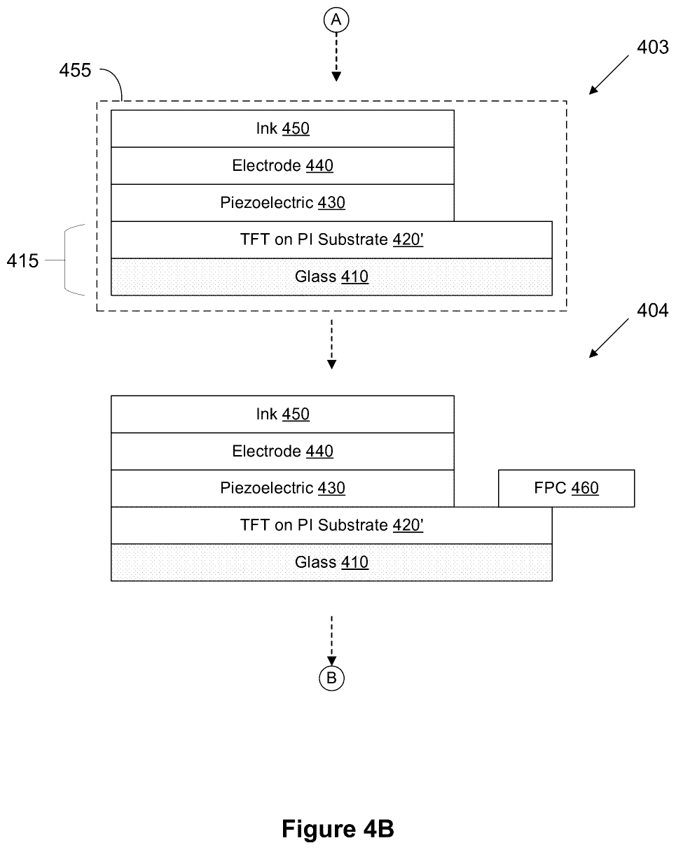

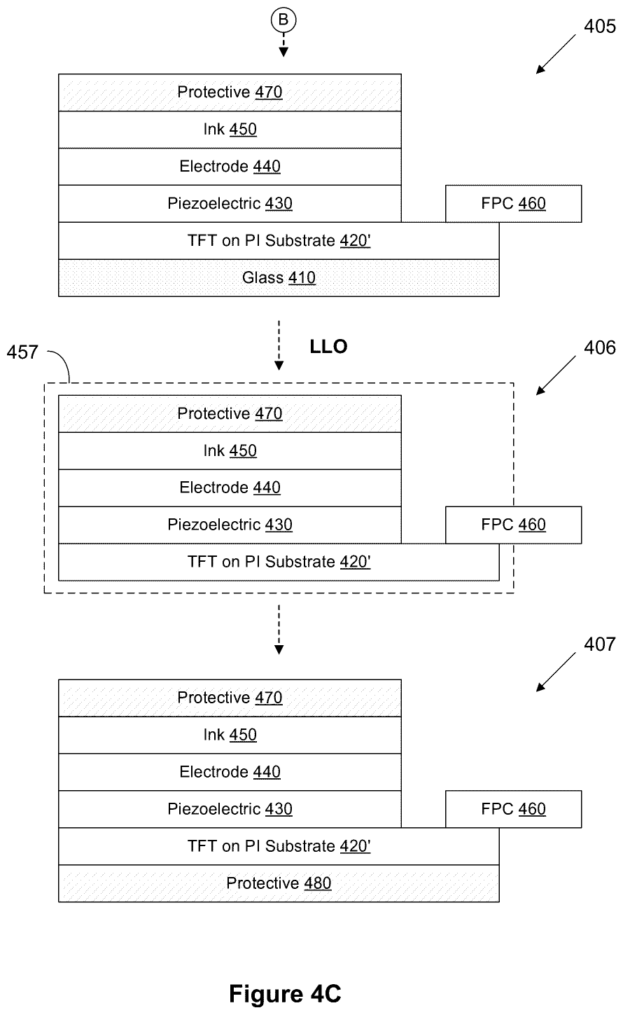

FIGS. 4A-4C illustrate a flow diagram of an example fabrication process

400 for a flexible acoustic sensor system on a thin-film transistor (TFT) layer 420, according to some embodiments. The example fabrication process 400 may include some or all of example process portions 401-407.

In some embodiments, the TFT layer 420 may be grown on a flexible substrate, which may be disposed on the layer of glass 410. The flexible substrate, in some embodiments, may be a polyimide (PI) substrate. While polyimide possesses softness and flexibility that may be used for applications such as flexible (e.g., foldable) devices, polyimide also has low creep (susceptibility to deformation from mechanical stresses) and a relatively high thermal resistance, and can stay stable during use and maintain properties in temperatures up to 450 F. In other embodiments, the flexible substrate may be another polymer substrate. Such a flexible substrate may provide the capability to conform to a curved surface or implement sensing techniques (e.g., acoustic sensing such as fingerprint sensing) with certain devices, such as flexible or foldable displays and devices.

Turning now to FIG. 4A, at 401, the TFT layer 420 on the flexible substrate may be disposed on a layer of glass 410, and a TFT substrate 420′ on a layer of glass 410 may be obtained at 402. The TFT layer 420 or the TFT substrate 420′ may also be referred to herein as a TFT device or a semiconductor device or a portion thereof. In some cases, the layer of glass 410 may be a large substrate or wafer made of glass (e.g., over 1 meter long, or over 1 square meter). Hence, the layer of glass 410 may comprise a glass substrate. In some examples, such a layer of glass 410 may have a thickness of about 500 μm, or may be thicker (e.g., 1 mm), and may provide a non-reactive surface for stabilizing the TFT layer 420. Collectively, a glass-based substrate 415 may be obtained from the layer of glass 410 and the TFT substrate 420′. Further components may be formed on the glass-based substrate 415, or in some specific approaches, on the TFT substrate 420′.

In some implementations, the TFT substrate 420′ may be formed with several layers, including a first electrode layer 422, a dielectric layer 424 (e.g., interlayer dielectric (ILD), a planarization layer 425, a second electrode layer 426, and one or more pixelated electrodes 428. In some cases, the TFT substrate 420′ may be formed via application of a plurality of masks, e.g., 10 masks, 12 masks, 13 masks.

In some configurations, the first electrode layer 422 may include one or more electrically conductive layers, e.g., a trilayer of titanium, aluminum, and titanium. In some configurations, the second electrode layer 426 may include one or more electrically conductive layers, e.g., indium tin oxide (ITO), which may be an alloy composed of indium, tin, and oxygen in a selected proportion (such as a 74% In, 8% Sn, and 18% O by weight). In some configurations, the second electrode layer 426 may be configured for electrical and/or communicative contact with at least a portion of the one or more pixelated electrodes 428. In some implementations, the one or more pixelated electrodes 428 may be part of an array of acoustic receiver elements, e.g., pixelated receiver electrodes.

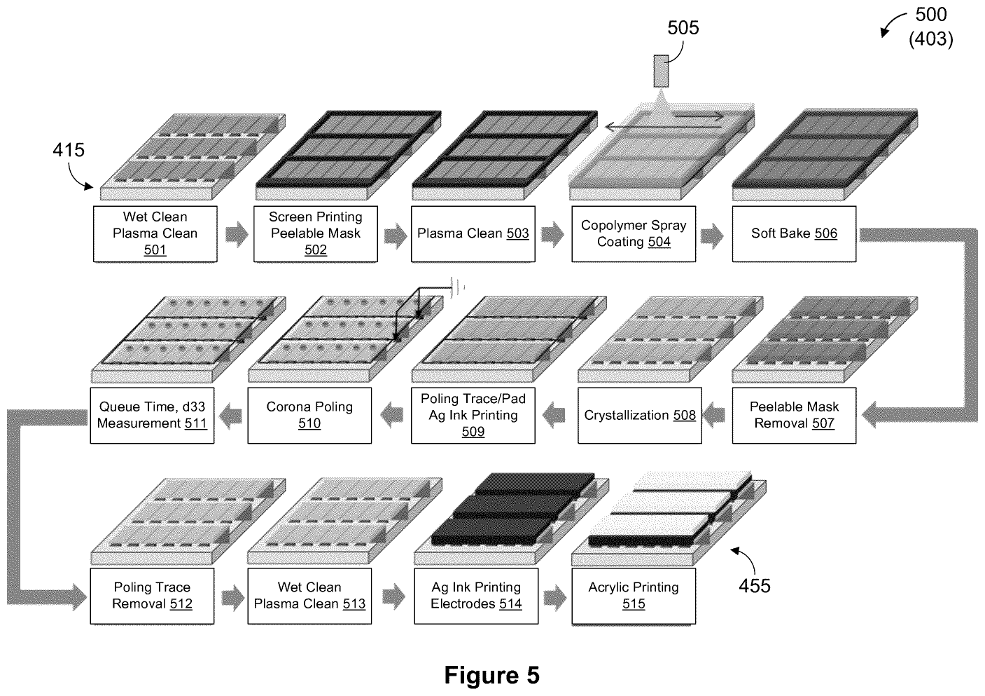

Turning to FIG. 4B, at 403, several additional layers may be formed over the glass-based substrate 415 to form a stack of materials 455. More specifically, in some approaches, a copolymer material such as a piezoelectric layer 430, an electrode layer 440, and a layer of ink 450 may be formed over one another as depicted. Example processes for forming these layers will be further discussed with respect to FIG. 5.

FIG. 5 shows a flow diagram of an example process 500 for formation of components of the flexible acoustic sensor system during the example fabrication process 400, according to some embodiments. More specifically, in some approaches, the example process 500 may generally correspond to 403 of the example fabrication process 400, and may include some or all of example process portions 501-515.

At 501, one or more cleaning processes may be performed on the glass-based substrate 415 obtained at 402, e.g., to remove contaminants. For example, a wet clean may be performed on the glass-based substrate 415 using a liquid chemical such as hydrogen fluoride (HF) (e.g., conducted at an atmospheric pressure environment). As another example, a plasma treatment may be performed, e.g., by igniting a plasma with a precursor gas in a pressurized environment (e.g., atmospheric pressure) or a vacuum. In some approaches, both a wet clean and a plasma treatment may be performed sequentially, in different processing environments. For example, bulk contaminants and particles could be removed using liquid chemicals, the glass-based substrate 415 and layer of glass 410 may be rinsed and/or dried, and then organic residues and fine contaminants that may remain may be removed using plasma treatment at, e.g., a plasma process station in a plasma process chamber of a plasma enhanced chemical vapor deposition (PECVD) apparatus or system. The opposite sequence of performing the plasma treatment and then the wet clean may also be performed in some cases.

At 502, a temporary protective layer (e.g., a peelable mask) may be applied to the glass-based substrate 415 and/or layer of glass 410 via screen printing. In some examples, a peelable mask composed of a ink or paste may be applied to peripheral regions on the layer of glass 410 around (to be) active areas of the glass-based substrate 415 which do not correspond to the active areas. In some examples, the ink or paste may be based on acrylic, silicone, or a polymer. In some examples, the ink or paste may be ultraviolet (UV) curable.

Further cleaning and/or surface treatment may be performed. For example, at 503, another plasma treatment may be performed on the glass-based substrate 415, e.g., at atmospheric pressure. As another example, a primer layer compatible with both the copolymer material (e.g., to be applied at 504) and the glass-based substrate 415 may be applied.

At 504, a copolymer material may be applied to the glass-based substrate 415. For example, the copolymer material (e.g., PVDF or PVDF-TrFE) may be coated onto the glass-based substrate 415. In some approaches, the copolymer material may be dissolved in a solvent (e.g., N,N-Dimethylformamide (DMF), Acetone, or Tetrahydrofuran (THF)), and the resulting solution may be spray coated (e.g., using a nozzle 505) for a desired thickness of the copolymer layer disposed (e.g., via spray coating) over the glass-based substrate 415. In some approaches, inkjet printing may be used. The copolymer material may be about 5-30 μm thick in some implementations. In some approaches, the copolymer layer may be laminated instead of coated or printed, especially when it is thicker, as it may be more difficult to print or coat.

In some cases, further processing may be done, e.g., to enhance its piezoelectric properties. For instance, the solvent may be dried to form a dry copolymer layer, the copolymer layer may be cured, and/or the copolymer layer may be annealed. In some examples, the annealing of the copolymer layer may include a soft bake at 506 to control the thickness and the roughness of the copolymer layer, e.g., at 70 degrees C. for 1 hour. In some approaches, the soft bake may be performed for 1.5 hours or 2 hours. The soft bake may be performed in a vacuum environment. In some approaches, the soft bake may be performed in a pressure of 0.001 millibar (mbar) or less. In some approaches, a drying time of 5 hours may be implemented after the soft bake.

At 507, the peelable mask may be removed without a solvent or mechanical scrubbing, without leaving residue or damaging the underlying material.

In some examples, the annealing of the copolymer layer may include crystallization at 508 to prime copolymer layer by aligning dipoles within the polymer chains to produce a net polarization. Crystallization may provide mechanical and thermal stability to the copolymer, which may allow the copolymer layer to maintain its piezoelectric properties under mechanical stress. In some examples, the crystallization process may be performed at about 135 C for 4 hours.

The resulting copolymer layer may correspond to the piezoelectric layer 430 shown in FIGS. 4B (formed at 403) and 4C.

At 509, one or more poling traces may be formed, to prepare for corona poling. In some approaches, a conductive ink, e.g., silver (Ag) ink, may be applied to the copolymer layer to create the poling traces.

At 510, corona poling may be performed, e.g., to align the dipoles in a piezoelectric material such as the copolymer layer and thereby polarize the material. Corona poling may allow control of crystal sizes, degree of crystallinity, and d33 (which may refer to the ratio of charge density to stress). In some examples, a high voltage (e.g., −16 kV±2 kV corona voltage and 5 kV±1 kV grid voltage) may be applied to a corona electrode for a period of poling time (e.g., 30 minutes) at a temperature of 25-80 C in dry air to create a corona discharge, creating a strong electric field across the copolymer layer. In other examples, other process conditions that would allow poling may be used. Corona poling can increase the sensitivity and performance of the copolymer layer and thus a sensor using the copolymer layer.

At 511, measurement of d33 may be performed after a post-poling queue time (e.g., 12-24 hours). The d33 measurement can be used to determine the piezoelectric coefficient of a material.

At 512, the poling traces may be removed.

At 513, one or more cleaning processes may be performed on the copolymer layer. For example, a wet clean and/or a plasma treatment (such as those mentioned above) may be performed on the copolymer layer.

At 514, at least one electrode layer may be formed. In some approaches, a conductive ink (e.g., Ag ink) may be applied onto the copolymer layer (e.g., piezoelectric layer 430). In some approaches, a further layer of ink may be applied to the electrode ink layer. In some approaches, the layer of ink may be a non-conductive ink that may form a passivation layer configured to protect electrodes from corrosion or chemical reactivity.

At 515, an acrylic layer may be printed on the at least one electrode layer and/or layer of ink. In some cases, the acrylic layer may be a passivation layer. In some implementations, a non-conductive ink, paste, or other die-attached film (DAF) may be used instead.

A stack of materials 455, which may include piezoelectric layer 430, electrode layer 440, and layer of ink 450, may thereby be formed (e.g., at example process portion 403) based on the above example process 500.

Referring back to FIG. 4B, at 404, the TFT substrate 420′ may be attached to a flexible circuit board (e.g., a flexible printed circuit (FPC) 460), as shown. In some cases, the FPC 460 may be at least partly disposed on or coupled to the TFT substrate 420′ rather than over another layer (e.g., piezoelectric layer 430, electrode layer 440, and layer of ink 450). That is, in some cases, the TFT substrate 420′ may be electrically and/or communicatively coupled with another system (e.g., a control system or a processor apparatus having one or more processors) via the FPC 460 or on the FPC 460. In some implementations, FPC 460 may be constructed of a polymer material (e.g., polyimide) such that the stack of materials shown can be deformed (e.g., bent) for use with a flexible sensor or device (e.g., foldable device).

Turning now to FIG. 4C, at 405, a first protective layer 470 may be disposed on the layer of ink 450 (or the electrode layer 440). The first protective layer 470 may be a protective film composed of a polymer (e.g., PET, polyurethane rubber, or TPU), and may prevent contamination or mechanical stresses on the side of the stack that does not have the layer of glass 410.

At 406, the layer of glass 410 may be removed, e.g., via laser liftoff (LLO). LLO may refer to a process that uses a UV-wavelength laser beam to separate thin layers from a substrate. In some approaches, LLO may be performed to separate the glass substrate (layer of glass 410) from the TFT substrate 420′ (still on a polymer layer, e.g., PI). This step may result in a stack of materials 457.

As an aside, in some implementations, LLO may be performed on a die level or chip level. In some implementations, LLO may be performed on a substrate (or subplate) level, e.g., on a wafer, where the glass substrate may have larger dimensions than when LLO is performed on a chip level. Note that FPC 460 may be attached to a glass substrate including layer of glass 410 while LLO is performed, as shown in FIG. 4C. This may indicate that, in some implementations of the example fabrication process 400, the LLO may be performed on a chip level after the wafer has been cut into smaller chips.

At 407, a second protective layer 480 may be attached to or disposed on the TFT substrate 420′, e.g., placed on the PI substrate. The second protective layer 480 may be a protective film composed of a polymer (e.g., PET, polyurethane rubber, or TPU). In some implementations, the first protective layer 470 and/or the second protective layer 480 may include PI. Generally, a polymer material that can provide protection to the stack of materials and maintain shape may be used. The first and second protective layers 470 and 480 may be the same or different in different implementations, and are temporary protective layers that can be later removed and omitted from a device in which the stack of materials 457 is implemented. With the first and second protective layers 470 and 480, it can be made easier to transport or handle the stack of materials 457, e.g., for subsequent processing without damage or contamination during subsequent processing.

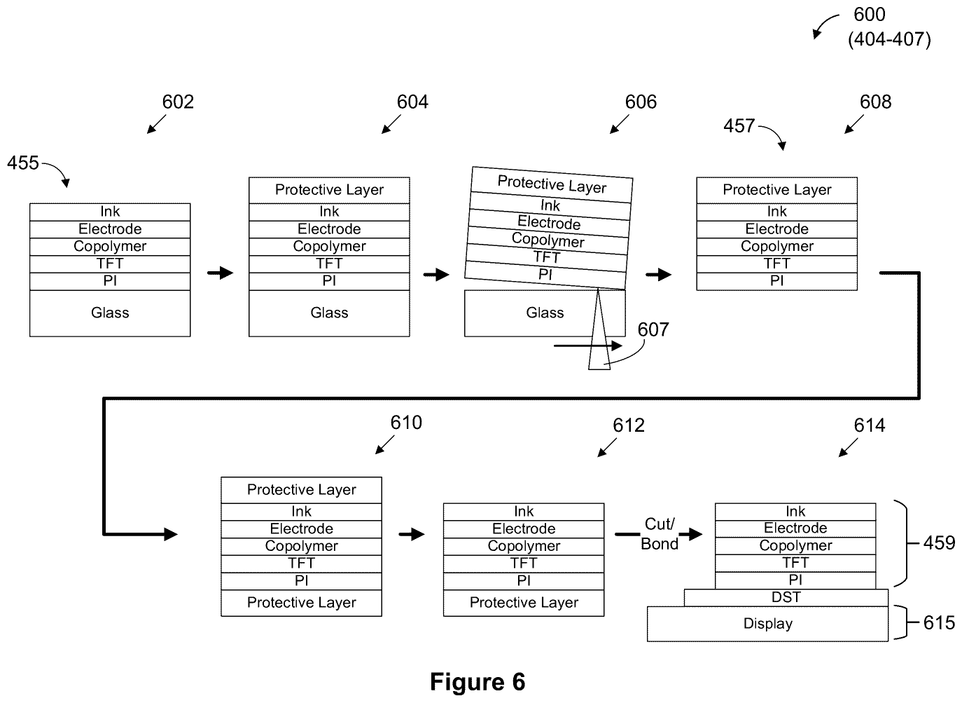

More specifically, FIG. 6 illustrates a flow diagram of an example process 600 for removal and addition of stabilizing components of the flexible acoustic sensor system during the example fabrication process 400, according to some embodiments. More specifically, in some approaches, the example process 600 may generally correspond to 405-407 of the example fabrication process 400, and may include some or all of example process portions 602-614.

At 602, a stack of materials (e.g., 455 as shown in FIGS. 4B and 5) may be obtained.

At 604, a first protective layer, e.g., of the type described above may be disposed on a layer of ink.

At 606, LLO may be performed. In some implementations, the LLO may be on a subplate level (e.g., performed on a large wafer), which is described further with respect to example fabrication process 800 discussed below. In some implementations, the LLO may be performed on a chip level (e.g., performed on cut portions of the wafer), which is described further with respect to example fabrication process 700 discussed below. In some cases, a laser 607 may be applied to a boundary between a substrate and thin films or layers thereon, e.g., swept or scanned across an area between the layer of glass 410 and the TFT substrate 420′ (e.g., PI). A bond between the layer of glass 410 and the TFT substrate 420′ may be broken by using a wavelength of the laser 607 which is absorbed by material at the interface between the thin layers and the TFT substrate 420′. In some example approaches, a laser 607 having a wavelength of about 248 or 343 nm having an energy of about 130 mJ/cm² and a frequency of about 10 kHz may be used at a moving speed of about 125 mm/s. Heating may occur in some cases as the laser energy is absorbed, which may lead to separation that lifts the thin layers away from the TFT substrate 420′ at the boundary between them.

The thin layers may thereby be separate from the rigid glass substrate such as the layer of glass 410 so that, e.g., they may be transferred elsewhere, to a display, an adhesive, another (flexible) substrate, etc. Advantageously, minimal damage to the thin and flexible film layers may be incurred while precisely separating them from the glass substrate, preserving their functionality.

At 608, a stack of materials 457 may be obtained after the layer of glass 410 is removed. The stack of materials 457 may include the first protective layer but not the rigid glass substrate (layer of glass 410).

At 610, a second protective layer may be attached to or disposed on the TFT substrate 420′, e.g., placed on the PI substrate. The first and second protective layers may prevent contamination or mechanical stresses on both sides side of the stack of materials 457. Such protective layers can make it easier to transport or handle the stack of materials 457, e.g., without damage or contamination during subsequent processing.

At 612, the first protective layer may be removed for processing. In some approaches, after removing the first protective layer (top protective film), the resulting stack of materials may be cut into desired dimensions. For instance, the stack of materials may comprise a large wafer, from which a single chip (or some smaller portion of the wafer) may be cut, e.g., using a diamond saw or laser scribing. Subsequently, the cut chip or portion of the stack may then be bonded or attached. In some examples, bonding may occur to a substrate, e.g., FPC. In some examples, bonding may occur to a display apparatus (e.g., via an adhesive layer such as DST). In some cases, a bare test may be performed on the cut chips or portions. Testing of individual dies can ensure that functional chips proceed to the costly packaging process. Thereafter, in some cases, the first protective film may be reattached.

At 614, the second protective layer may be removed, and the resulting stack, including a stack of materials 459 (including, e.g., TFT substrate 420′, piezoelectric layer 430, electrode layer 440, layer of ink 450) may be included in or incorporated with another component or device.

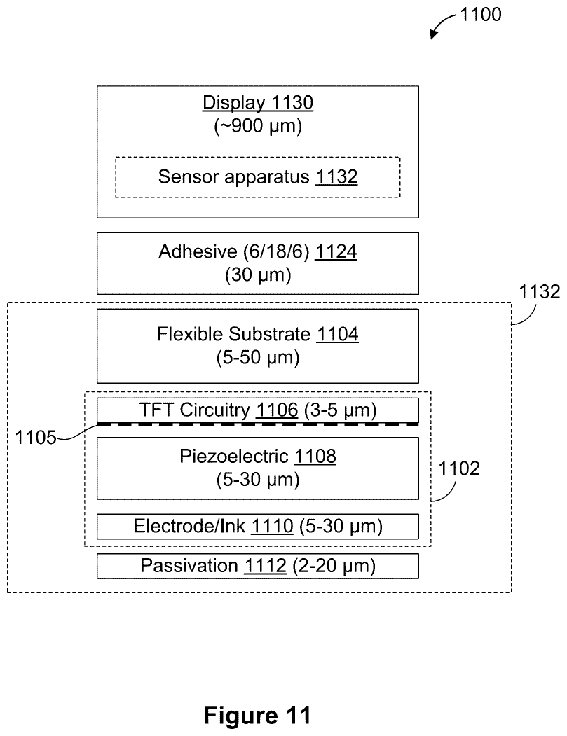

For example, the stack of materials 459 may be attached or adhered (e.g., directly laminated) to a display apparatus 615 via an adhesive layer (e.g., double-sided tape (DST)). In some implementations, such a DST may include a first layer of a pressure-sensitive adhesive (PSA), a layer of copper (Cu), and a second layer of PSA. In some examples, each of the PSA layers may be about 6 μm thick, and the Cu layer may be about 18 μm thick. In other implementations, the stack of materials 459 may be embedded in the display apparatus 615. Both types of implementations will be explained below with respect to FIG. 11.

However, the resulting stack may be implemented with other components, for example, a polymer-based substrate, including one having an acoustic impedance or characteristic compatible with a surface of interest. As an example, a flexible sensor in a patch form factor that can be applied to a user's skin may be formed.

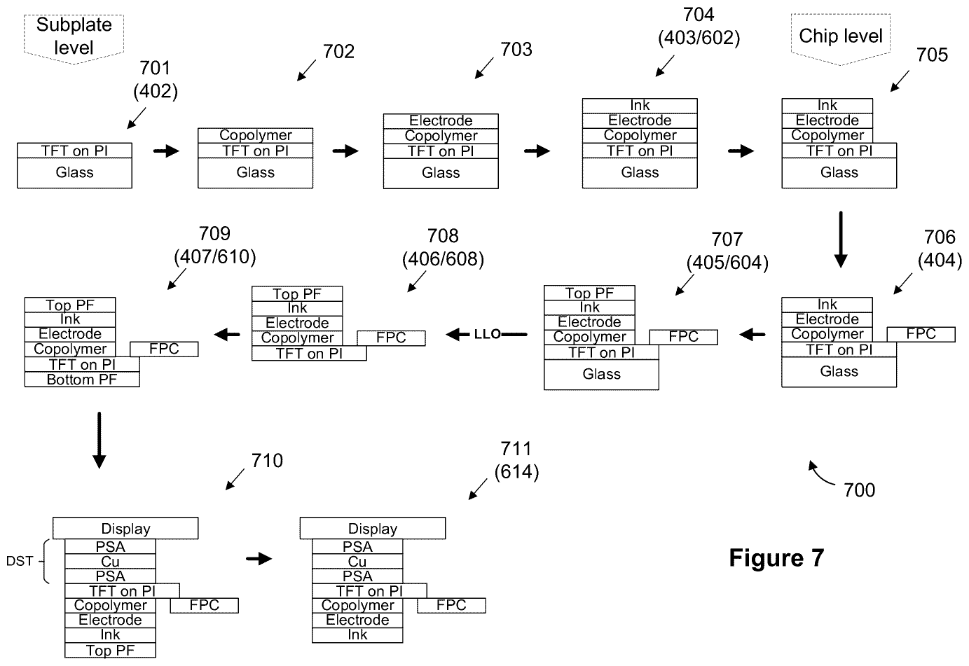

Now turning to FIG. 7, a flow diagram of another example fabrication process 700 is shown for a flexible acoustic sensor system on a TFT layer using a chip-level LLO process, according to some embodiments. As mentioned above, LLO may be performed at the chip level or the subplate level. The example fabrication process 700 may be used when obtaining a portion of a larger wafer (a die or a chip) and performing LLO thereon.

At 701, a TFT layer on a flexible substrate such as a PI substrate (e.g., TFT layer 420) may be disposed on a glass substrate (e.g., a layer of glass 410), similar to 402 shown in FIG. 4A.

At 702, a copolymer material (such as piezoelectric layer 430) may be coated on the TFT layer. At 703, an electrode layer may be formed on the copolymer material, e.g., Ag printing to deposit a layer of silver to form an electrode or conductive pattern. At 704, a layer of ink may be formed over the electrode layer, e.g., using ink printing. Through 702-704, a stack of materials may be formed, such as that shown at 403 or 602.

At 705, one or more cuts to the stack of materials and the underlying substrate, including the glass substrate, may be made to obtain portions of the stack (chips). One or more chips may be obtained from cutting (e.g., hundreds of separate and identical chips which may include portions of the glass substrate).

At 706, an FPC (such as 460) may be disposed onto the TFT substrate, e.g.,

according to 404. At 707, a first protective layer or film may be formed or disposed on the layer of ink, e.g., according to 405 or 604.

At 708, LLO may be performed to separate the glass substrate from the TFT substrate. In some approaches, the LLO may be performed on a chip or die obtained from the cutting performed at 705 (as opposed to a whole wafer as done in example fabrication process 800 discussed below). As a result, a stack of materials may be formed, e.g., according to 406 or 608 to obtain a stack of materials such as 457.

At 709, a second protective layer or film may be attached to the TFT substrate, e.g., according to 407 or 610. In some implementations, the second protective layer may include a flexible substrate. In some cases, the flexible substrate may be composed of a polymer (e.g., PET, polyurethane rubber, or TPU). The flexible substrate may allow the stack of materials to be secured and/or transported together without exposing sensitive components such as TFT circuitry to contaminants or stresses.

At 710, additional components such as an adhesive layer (e.g., DST) and a display apparatus (e.g., OLED). In some implementations, the adhesive layer may include a layer of Cu between layers of PSA. The adhesive layer may be disposed on the TFT layer after the second protective layer has been removed, and the stack of materials may be laminated under the display apparatus, e.g., via the TFT layer, using the adhesive layer.

At 711, the first protective layer may be removed, which may result in a display stack. In some examples, this display stack may be an example of the stack obtained as a result of 614. The resulting display stack may be included in or incorporated with a device.

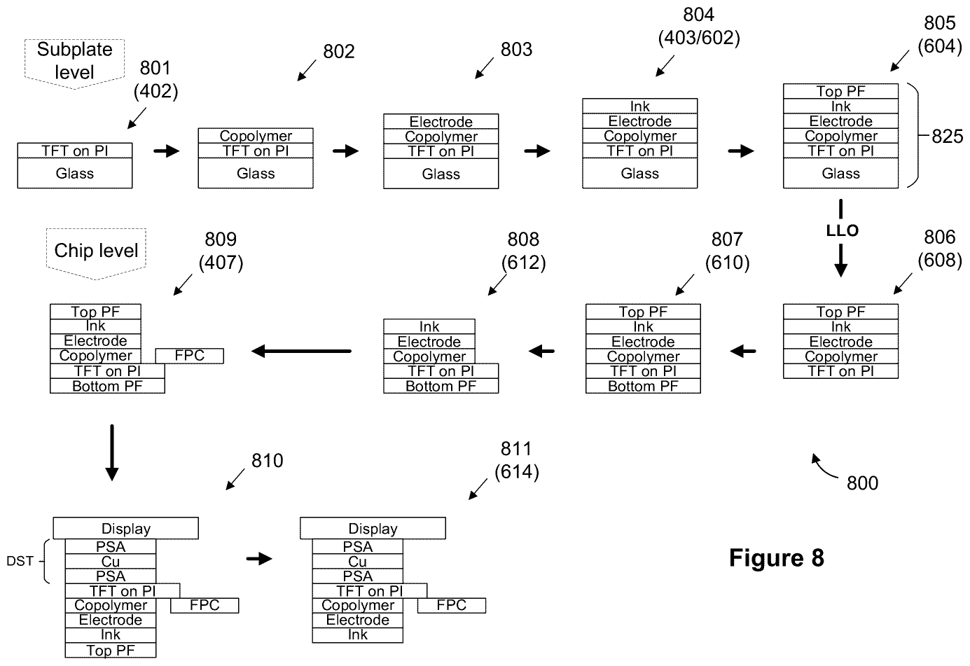

FIG. 8 shows another example fabrication process 800 for a flexible acoustic sensor system on a TFT layer using subplate level LLO, according to some embodiments.

In some approaches, 801-804 may be similar to 701-704 and may result in a stack of materials being formed, such as that shown at 403 or 602.

At 805, a first protective layer or film may be formed or disposed on the layer of ink, e.g., according to 604. Note that components that may be associated with downstream chip-level processes, such as an FPC, may not be provided at this point.

Instead, at 806, LLO may be performed on the stack of materials 825 having the first protective layer. Specifically, the LLO performed at 806 may be subplate-level LLO performed on a larger wafer, including, e.g., a glass substrate that has not been cut.

The example fabrication process 800 may continue to 807, where a second protective layer or film may be attached to the TFT layer, e.g., according to 610. In some examples, the second protective layer may be a flexible substrate.

At 808, the first protective layer may be removed. At 809, one or more cuts to the stack of materials and the underlying substrate, including the glass substrate, may be made to obtain portions of the stack, such as chips or dice from the larger wafer.

In some approaches, 810 and 811 may be similar to 710 and 711, respectively. That is, the second protective layer may be removed, a display apparatus (e.g., OLED) may be laminated to the TFT layer via an adhesive layer (e.g., Cu layer between PSA layers), and the first protective layer may be removed. The resulting display stack (e.g., as obtained as a result of 614) may be used in further downstream implementations.

As discussed above, LLO may be performed to separate the glass substrate layer in different scenarios and according to different recipes. Some differences between the example fabrication process 700 of FIG. 7 (including chip-level LLO) and the example fabrication process 800 of FIG. 8 (including subplate-level LLO) may include the size or dimensions of the glass substrate during the respective processes (subplate-level LLO may be performed on a larger wafer), and FPC bonding in the fabrication process 800 may occur after performing LLO and after attaching the second (bottom) protective film; the first (top) protective film is then attached after FPC bonding. In example fabrication process 700 (and 400), FPC bonding may occur before attachment of the first (top) protective film, performance of LLO (chip level), and attachment of the second (bottom) protective film. Since the wafer may already be cut into chips, the smaller stack dimensions may facilitate FPC bonding on the stack.

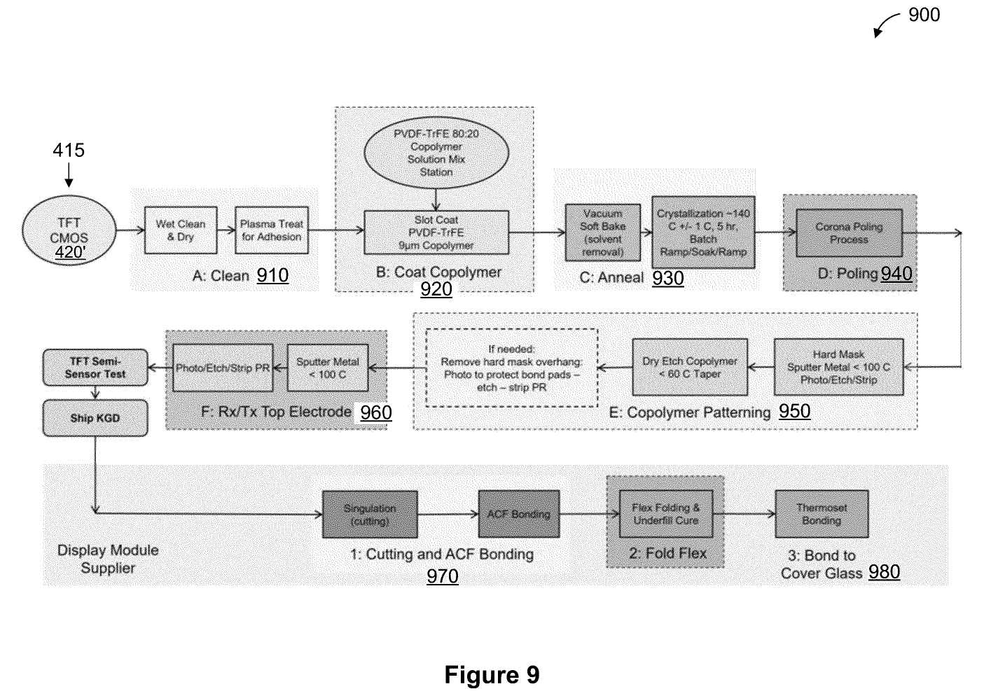

FIG. 9 is a flow diagram of an example process 900 for manufacturing a flexible acoustic sensor apparatus, according to some embodiments. Example process 900 may include example process portions 910-960 to fabricate a sensor element configured to perform, e.g., transmitting and receiving of acoustic signals. After 910-960, the sensor element may undergo further processing and implementation with another device (e.g., a display or portion thereof) at example process portions 970-980.

In some approaches, at example process portion 910, a TFT substrate may be obtained, and one or more cleaning process may be performed. The TFT substrate may be an example of TFT substrate 420′. In some implementations, the TFT substrate 420′ may be part of a glass-based substrate such as 415 obtained at 402. In some examples, example process portion 910 may correspond to at least a portion of example process portion 403 or example process 500. For example, a wet clean and a plasma treatment may be performed as discussed with respect to example process portion(s) 501, 502 and/or 503.

In some approaches, at example process portion 920, a copolymer material may be coated onto the TFT substrate. In some examples, example process portion 920 may correspond to at least a portion of example process portion 403 or example process portion 504. In some examples, an 80:20 PVDF-TrFE copolymer solution may be applied to the TFT substrate. In some examples, the resulting copolymer layer may have a thickness of about 5 to 10 μm or up to 30 μm (e.g., 9 μm).

In some approaches, at example process portion 930, an annealing process may be performed on the copolymer layer. In some examples, example process portion 930 may correspond to at least a portion of example process portion 403 or example process portion(s) 506-508. For example, a soft bake may be performed, e.g., according to 506 in a vacuum environment, e.g., to remove the solvent from the coating of the copolymer material. Furthermore, the copolymer layer may be crystallized (e.g., according to 508). In some examples, the crystallization may be performed at about 140 C for 5 hours. As may be noticed, process conditions may vary, e.g., 135 C for 4 hours according to 508, or 140 C for 5 hours according to 930.

In some approaches, at example process portion 940, corona poling may be performed. In some examples, example process portion 940 may correspond to at least a portion of example process portion 403 or example process portion(s) 509 and/or 510. That is to say, a voltage may be applied to the annealed copolymer layer to create an electric field in the copolymer layer.

In some approaches, at example process portion 950, a copolymer patterning process may be performed. Example process portion 950 may include applying a hard mask, sputtering, and/or performing photolithography processes such as etching and/or photoresist stripping to remove leftover photoresist after etching. A dry etch may be performed (e.g., at below 60 C). In some cases, if needed, hard mask overhang may be removed, and further photolithographic processing may be performed (e.g., etching and photoresist stripping).

In some implementations, the resulting copolymer layer may be a piezoelectric component that converts received acoustic (e.g., ultrasonic) waves into electrical energy, which may be detected by the TFT substrate. This copolymer layer may be an example of piezoelectric layer 430. The TFT substrate may include one or more acoustic receiver elements. In some implementations, the one or more acoustic receiver elements may correspond to one or more pixelated electrodes having associated TFT circuitry formed as part of the TFT substrate. In some examples, acoustic receiver system 104b may include the one or more acoustic receiver elements.

In some approaches, at example process portion 960, an electrode layer may be formed. In some embodiments, the electrode layer may be an example of electrode layer 440 and may correspond to one or more acoustic transmitter elements. In some examples, acoustic transmitter system 104a may include the one or more acoustic transmitter elements. In some examples, example process portion 960 may correspond to at least a portion of example process portion 403 or example process portions 514.

In some cases, at example process portion 960, sputtering may occur (e.g., under 100 C) to deposit a uniform metallic layer, such as a thin copper (Cu) layer. Further photolithographic processing may occur (e.g., etching and photoresist stripping). In alternate cases, a conductive ink (e.g., Ag ink) may be applied.

The resulting stack of materials after example process portion 960 may be an example of stack of materials 455. In some approaches, at least one protective layer (e.g., 470) may be placed on the resulting stack of materials, as the TFT substrate and the other layers may be susceptible to mechanical stress and/or insufficiently stiff to handle (transport, remove, etc.).

In some approaches, testing may be performed to measure performance and integrity of the resulting stack of materials. A known good die (KGD) that meets or exceeds performance requirements may be considered an independent sensor component that can, e.g., be processed further.

For instance, at example process portion 970, singulation cutting may occur, where a wafer or substrate (e.g., layer of glass 410) on which the resulting stack of materials is disposed can be separated into individual sensor elements (e.g., chips).

In some cases, the glass substrate may be removed and separated from the resulting stack of materials, e.g., via LLO according to example process portion 606, before or after the singulation cutting. In some cases, adhesion and bonding may take place between a sensor element and a substrate such as a circuit board, or another layer (e.g., backplate, stiffening layer) using, e.g., anisotropic conductive film (ACF) bonding. Furthermore, in some cases, an underfill (e.g., an epoxy that connects a chip to a board) may be cured.

In some approaches, example process portion 980, the sensor element may be bonded to a display element, such as a cover glass (e.g., ultra-thin glass (UTG) that possesses high flexibility) and/or other components of a display (e.g., foldable display).

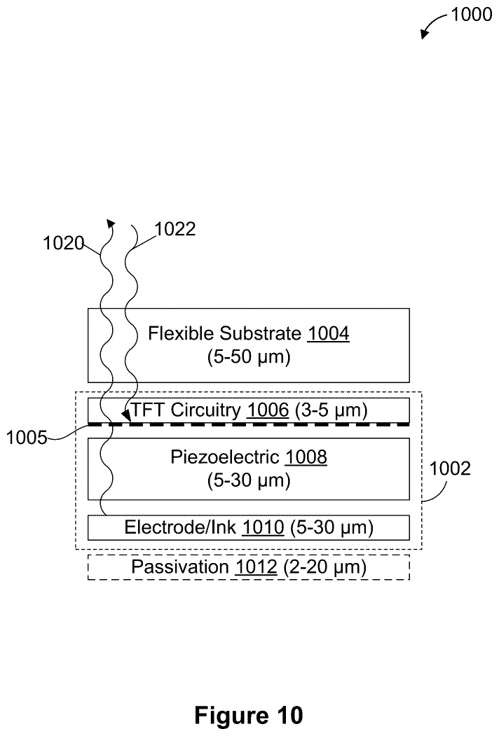

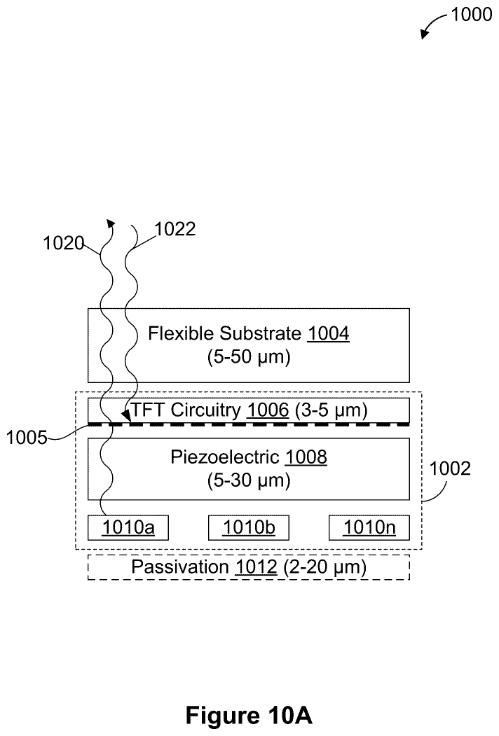

The example process 900 may thereby result in a flexible acoustic sensor apparatus, which may be implemented in a flexible device. Examples of stacks of materials of the flexible acoustic sensor apparatus are discussed further below with respect to FIGS. 10 and 11.

Note that some process steps may be omitted as compared to conventional manufacturing methods. For instance, thinning process or certain dehydrogenation steps may be omitted when manufacturing the flexible acoustic sensor apparatus as disclosed herein.

In conventional manufacturing of flexible devices, there may be performance issues that arise. For instance, there may be lower TFT mobility (u) and a large threshold voltage (Vth) variation, depending at least on the process. Low mobility may result in lower refresh rates and responsiveness, since fewer charge carriers (electrons or holes) can move when an electric field is applied. Variations in the minimum gate voltage (the Vth) required to create a conductive channel between the source and drain terminals of the TFT can result in non-uniform switching and inconsistencies in the performance of the transistors. However, the example processes for manufacturing the flexible sensor apparatus may mitigate such performance issues modifying the associated circuitry to compensate for u and to reduce Vth shift. In some approaches, to make the circuitry less sensitive to u, the circuit may be made larger. In some approaches, making the pixel performance uniform may compensate for Vth variation.

In some approaches, to compensate for mechanical strain or stress and/or thermal expansion within the sensor element, a dioxide layer (e.g., silicon dioxide (SiO2)) or a nitride layer (e.g., silicon nitride (SiN)) may be added as a buffer layer during a process for fabrication of the TFT layer 420. Buffer layers may have low electron affinity and can be deposited between semiconductor layers during fabrication of the TFT layer 420.

The aforementioned PECVD apparatus or system may be used for the deposition in some approaches. In other approaches, other chemical vapor deposition (CVD) techniques could be used: low pressure chemical vapor deposition (LPCVD), atmospheric pressure chemical vapor deposition (APCVD), metal organic chemical vapor deposition (MOCVD), atomic layer deposition (ALD), plasma enhanced atomic layer deposition (PEALD), or through direct metal deposition (DMD), etc. based on the precursors chosen.

In some implementations, an uneven flexible (e.g., PI) substrate may be formed, which may result in performance improvement in the acoustic transmitter elements or the acoustic receiver elements. More specifically, it has been found by the assignee hereof that controlling the topography of the layers of a stack of materials by constructing a height difference between the acoustic transmitter elements and the acoustic receiver elements can result in greater performance in the acoustic transmitter elements or the acoustic receiver elements.

### Example Sensor Stacks

FIG. 10 is a cross-sectional diagram of an example stack of materials 1000 usable with embodiments of the flexible acoustic sensor system disclosed herein. In some embodiments, the example stack of materials 1000 may include a sensing element 1002 and a substrate 1004. In some implementations, the sensing element 1002 may include TFT circuitry 1006, a piezoelectric layer 1008, an electrode layer 1010, and a passivation layer 1012.

The example stacks illustrated in the Figures are not necessarily depicted to scale.

As noted earlier, a “sensing element” may refer collectively to a transmitter element and a receiver element, such as an acoustic (e.g., ultrasonic) transmitter element and an acoustic (e.g., ultrasonic) receiver element. In some applications, the sensing element may be a fingerprint sensor or a part thereof. Hence, in some embodiments, the sensing element 1002 may include an acoustic transmitter element and an acoustic receiver element, which may be examples of acoustic transmitter system 104a and acoustic receiver system 104b.

In some embodiments, the substrate 1004 may be constructed of a flexible material and thus may be a flexible substrate, which may be an example of flexible substrate 103. In some implementations, the substrate 1004 may comprise polyimide. In some examples, the substrate 1004 may be about 5-50 μm thick. In some implementations, the substrate 1004 may comprise another polymer, such as those listed above. As such, the sensing element 1002 may conform to a curved surface (such as a curved platen, foldable display, acoustic lens, etc.). In some cases, the sensing element 1002 may be directly laminated to a curved surface via the substrate 1004.

In some implementations, the sensing element 1002 may be disposed adjacent to other components such as a flexible substrate, e.g., substrate 1004. In some configurations, by virtue of the flexibility possessed by the sensing element 1002, at least portions of the sensing element 1002, as well as the substrate 1004, may deform and conform to a curved surface.

In some configurations, the substrate 1004 may also include components (not shown) that form a system with the sensor element 1002, such as passive components, a control system (e.g., control circuitry such as an ASIC and/or a processor apparatus having one or more processors), and/or other components. These components may be electrically and/or communicatively coupled with at least the sensing element 1002, enabling signal and/or data communication between the sensing element 1002 and the components. For example, a transmit signal may be sent from the control system to the sensing element 1002 (e.g., to an acoustic transmitter element such as the electrode layer 1010), and a receive signal from the sensing element 1002 (e.g., from an acoustic receiver element such as TFT circuitry 1006 and/or a receiver pixel 1005) may be received at the control system.

In some embodiments, the sensing element 1002 may be configured to transmit one or more acoustic signals 1020 (e.g., ultrasonic waves). For example, the acoustic signals 1020 may travel toward a platen (not shown) and/or a target object (e.g., a body part of a user, such as a finger placed against the platen). In some configurations, the one or more acoustic signals 1020 may be generated based on the transmit signal applied to the electrode layer 1010.

The sensing element 1002 may be further configured to receive and detect one or more returning acoustic signals 1022 (e.g., reflected ultrasonic waves) from, e.g., the target object. In some implementations, thin-film transistors (TFTs) may be grown on the flexible substrate 1004 (e.g., through a fabrication process) and thereby form the TFT circuitry 1006. TFT circuitry 1006 may include one or more discrete (or pixelated) portions that form at least part of corresponding one or more acoustic receiver elements (represented by one or more receiver pixels 1005, each of which forms part of the TFT circuitry 1006), in conjunction with the piezoelectric layer 1008. In some examples, the one or more pixelated portions may be one or more pixelated receiver electrodes having associated TFT circuitry of the TFT circuitry 1006.

As noted elsewhere herein, one or more acoustic transmitter elements and one or more receiver elements may share and use the same piezoelectric layer 1008. More specifically, in some scenarios, the one or more acoustic signals 1020 may be emitted from the boundary between the piezoelectric layer 1008 and the electrode layer 1010, and mechanical energy from the one or more returning acoustic signals 1022 received at the piezoelectric layer 1008 may be converted to electrical signals (via the piezoelectric layer 1008) that are detected by the one or more receiver pixels 1005 of the TFT circuitry 1006 which are disposed between the boundary between the piezoelectric layer 1008 and the TFT circuitry 1006. Although the layers in FIG. 10 are depicted as being separate elements, they may be in direct contact with one another with adjacent layer(s). In some cases, a layer or component may be attached (e.g., laminated via an adhesive) to another layer or component, formed on a layer, or abut against another layer.

In some examples, the layer of TFT circuitry 1006 may be about 3-5 μm thick. The piezoelectric layer 1008 in some implementations may include a PVDF or PVDF-TrFE copolymer. In some implementations, the piezoelectric layer 1008 may include lead magnesium niobate/lead titanate (PMN-PT), lithium niobate (LiNbO3), or a combination thereof. In some implementations, the piezoelectric layer 1008 may be a multilayer piezoelectric structure, or an array of such structures. In some examples, the piezoelectric layer 1008 may be about 5-30 μm thick.

The electrode layer 1010 may be an example of an acoustic transmitter element or a portion thereof. In some implementations, the electrode layer 1010 may include silver (Ag), e.g., in the form of conductive ink applied to the piezoelectric layer 1008. In some implementations, the electrode layer 1010 may include a thin metallic layer. In some cases, the thin metallic layer may be composed of copper (Cu), which would be pliable enough to allow the sensor element 1002 conform to a curved surface. In some examples, the electrode layer 1010 may be about 5-30 μm thick. In implementations in which a thicker Ag is used, Ag may be applied (e.g., printed) multiple times.

In some implementations, as shown in FIG. 10A, although the electrode layer 1010 may be referred to herein as an acoustic transmitter element (or one or more acoustic transmitter elements), electrode layer 1010 may include one or more electrode portions (or pixels) 1010a , 1010b and/or 1010n , which may correspond to one or more acoustic transmitter elements. Each of electrode portions 1010a , 1010b , 1010n may be conductive ink or layer as noted above with respect to electrode layer 1010.

Returning back to FIG. 10, control circuitry and/or processing apparatus may drive transmit signals to the electrode layer 1010, which may in turn cause generation and emission of acoustic waves from the electrode layer 1010. In some examples, the control system may be configured to provide a voltage (e.g., 100-200 V, such as 120 V) to the electrode layer 1010 (e.g., via a resonating circuit in passive components), the voltage causing the electrode layer 1010 to generate the one or more acoustic signals at a frequency (e.g., 1-25 MHz or 5-15 MHz, such as 7, 8, 10, 12 or 15 MHz). In general, higher frequency can provide a better resolution but sacrifice on transmission (higher decibel (dB) loss). A balance may be struck when selecting the frequency. Hence, the electrode layer 1010 may be configured to emit acoustic (e.g., ultrasonic) signals and function as an acoustic transmitter element.

In some implementations, a passivation layer 1012 may be included with the example stack of materials 1000. In some cases, passivation may 1012 include a protective coating (e.g., a non-conductive ink) applied to the sensor element 1002 (or a portion thereof, such as the electrode layer 1010) to make the sensor element or a surface thereof less susceptible to damage (e.g., chemical reactivity, corrosion) and increase electrical stability. In some cases, passivation layer 1012 may include a polymer layer, such as DAF or an acrylic. In some examples, the passivation layer 1012 may be about 2-20 μm thick.

Based on the above, it can be seen that the components of the example stack of materials 1000 may be made of flexible materials. More specifically, in some examples, the TFT circuitry 1006 may be grown on a flexible substrate 1004, the piezoelectric layer 1008 may be made of copolymer, the electrode layer 1010 may be made of conductive (Ag) ink or thin Cu, and passivation layer 1012 may be a protective coating. Hence, the example stack of materials 1000 (including the sensing element 1002) may be a flexible stack and sensor element that can conform to curved surfaces and be used with flexible devices (e.g., foldable displays, wearable devices, devices with a curved surface).

Variations of the example stack of materials 1000 may open avenues for use in different applications. In some cases, the example stack of materials 1000 may be used with a flexible devices as noted above. In some cases, different configurations of stacks of materials having additional and/or different components as the example stack of materials 1000 may result in stacks that may be used in further applications as discussed below.

FIG. 11 is a cross-sectional diagram of an example implementation of a sensor stack 1100 in a device having a display apparatus 1130. In some examples, the sensor stack 1100 may include the display apparatus 1130, an adhesive layer 1124, and a sensor apparatus 1132.

In some embodiments, the sensor apparatus 1132 may correspond to example stack of materials 1000, and may include a substrate 1104 (which may be an example of substrate 1004), TFT circuitry 1106 (which may be an example of TFT circuitry 1006), a piezoelectric layer 1108 (which may be an example of piezoelectric layer 1008), an electrode layer 1110 (which may be an example of electrode layer 1010), and/or a passivation layer 1112 (which may be an example of passivation layer 1012). A sensor element 1102 may comprise the TFT circuitry 1106 (including one or more receiver pixels 1105), piezoelectric layer 1108, and electrode layer 1110. In other words, the sensor apparatus 1132 may correspond to or include the example stack of materials 1000 (or other example stacks disclosed herein).

In some embodiments, the display apparatus 1130 may include various components. Display apparatus 1130 may in some cases be a flexible (e.g., foldable) display.

In some examples (e.g., in a flat-panel display), the display apparatus 1130 may include a glass layer (e.g., cover glass), an optically clear adhesive (OCA) layer, a polarizing layer, one or more pressure sensitive adhesive (PSA) layers, a light-emitting layer (such as an OLED panel on a substrate, such as a polyimide or another polymer substrate), a backplate, or a combination thereof.

In some examples, (e.g., in a foldable display), the display apparatus 1130 may include a polymer layer, an OCA layer, a glass layer (e.g., ultra-thin glass (UTG)), a polarizing layer, a light-emitting layer (which may include, e.g., an OLED panel on a substrate, such as a polyimide or other polymer substrate), one or more PSA layers, one or more protective layers (e.g., cushions, adhesives), a stiffening layer (e.g., stainless steel, titanium, aluminum, carbon fiber-reinforced polymer (CFRP)), or a combination thereof.

In some examples, the display apparatus 1130 may be approximately 900 μm, although it may vary to some degree (e.g., 500-1000 μm).

In some embodiments, the sensor apparatus 1132 may be secured or adhered (e.g., directly laminated) to the display apparatus 1130, e.g., via an adhesive layer 1124. In some implementations, the adhesive layer 1124 may include a double-sided adhesive that includes a first layer of a pressure-sensitive adhesive (PSA), a layer of copper (Cu), and a second layer of PSA. In some examples, each of the PSA layers may be about 6 μm thick, and the Cu layer may be about 18 μm thick. Thus, the adhesive layer 1124 may be about 30 μm thick.

In some embodiments, however, the sensor apparatus 1132 may be embedded in the display apparatus 1130. That is, the sensor apparatus 1132 may be part of the display apparatus 1130. Since the display apparatus 1130 may be a flexible (e.g., foldable) display, and since the sensor apparatus 1132 may also be a flexible sensor element, at least the portion of the device implementing the sensor stack 1100 may be flexible (e.g., foldable).

Notably, the display apparatus 1130 may be substantially thicker (e.g., about 900 μm) than the sensor apparatus 1132 (e.g., about 25-135 μm, or about 100 μm in some examples). Hence, in some implementations, the display apparatus 1130 may easily integrate or incorporate the sensor apparatus 1132, e.g., packaged as a lightweight additional part of the display or a device, whether adjoined or laminated, or embedded therein.

### Example Methods

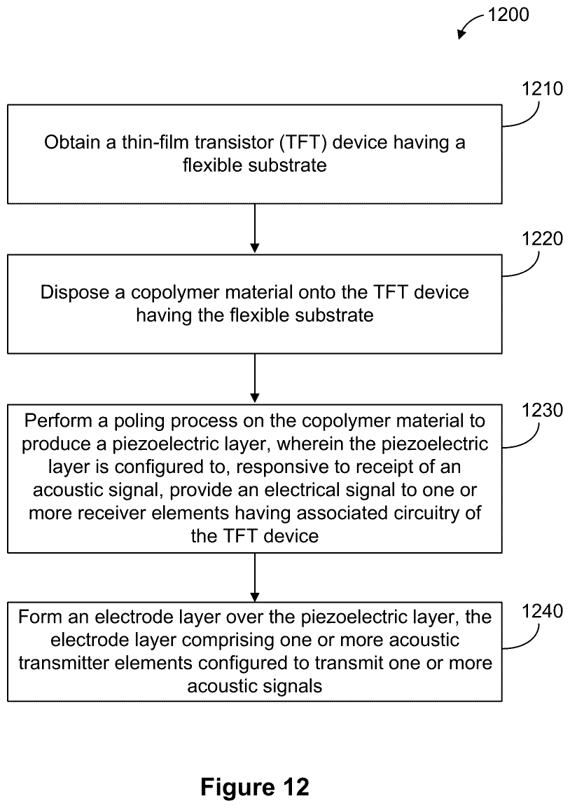

FIG. 12 a flow diagram of an example method 1200 for fabrication of a flexible acoustic sensing apparatus, according to some embodiments. Structure for performing the functionality illustrated in one or more of the blocks shown in FIG. 12 may be performed by hardware and/or software components, such as a control system, of an apparatus or system. Examples of such apparatus or system may include a semiconductor fabrication apparatus or system, or one or more components thereof, e.g., a process chamber or a process station, precursor reactant gas line(s) and inlet(s), radio frequency (RF) power source (e.g., to generate plasma). Such apparatus or system may be communicatively coupled with the control system (including one or more processors), a memory, and/or a computer-readable apparatus including a storage medium storing computer-readable and/or computer-executable instructions that are configured to, when executed by the control system, cause the control system, the one or more processors, or the apparatus or system to perform operations represented by blocks below. Other example components are mentioned elsewhere herein, e.g., a nozzle, a laser.

The method outlined in FIG. 12 may include more or fewer blocks than indicated. Moreover, the blocks of methods disclosed herein are not necessarily performed in the order indicated. In some instances, one or more of the blocks shown in FIG. 12 may be performed concurrently.

At block 1210, the method 1200 may include obtaining a thin-film transistor (TFT) device having a flexible substrate. In some embodiments, the flexible substrate may include polyimide. In other embodiments, the flexible substrate may include another polymer material.

In some embodiments, the TFT device having the flexible substrate may be disposed on a glass substrate; and the method 1200 may further include, subsequent to the forming of the electrode layer over the piezoelectric layer, performing a laser liftoff (LLO) to separate the glass substrate from the TFT device having the flexible substrate. In some implementations, the method 1200 may further include applying a first protective layer (e.g., 470) over the electrode layer prior to the performing of the LLO, the first protective layer including, e.g., PET, polyurethane rubber, or TPU. In some implementations, the method 1200 may further include applying a second protective layer (e.g., 480) to an exposed surface of the TFT device created by the LLO, the second protective layer including, e.g., PET, polyurethane rubber, or TPU.

In some embodiments, the obtaining of the TFT device may further include adding a buffer layer during fabrication of the TFT device. In some implementations, the buffer layer may include silicon dioxide (SiO2) to increase thermal resistance and mechanical resistance of the obtained TFT device.

At block 1220, the method 1200 may include disposing a copolymer material onto the TFT device having the flexible substrate. In some approaches, the disposing of the copolymer material may include spray coating the copolymer material using a nozzle, e.g., until a copolymer layer having a thickness of about 5-30 μm is coated on the TFT device. In some approaches, the copolymer material may be printed onto the TFT device, e.g., using inkjet printing. In some approaches, the disposing of the copolymer material may include laminating a copolymer layer on the TFT device.

At block 1230, the method 1200 may include performing a poling process on the coated copolymer material to produce a piezoelectric layer. In some embodiments, the piezoelectric layer may be configured to, responsive to receipt of an acoustic signal, provide an electrical signal to one or more receiver elements having associated circuitry of the TFT device.

In some embodiments, the poling process may include a corona poling process, and in which a corona voltage and a grid voltage each exceeding 4 kilovolts (kV) are applied for a poling time of 30 minutes at a temperature between 25 and 80 C in dry air.

In some embodiments, the method 1200 may further include, subsequent to the disposing of the copolymer material and prior to the poling process, performing an annealing process on the copolymer material. In some approaches, the annealing process may include a soft bake at 70 C for 1 hour under a pressure of 0.001 millibar (mbar) or less, a crystallization process at 135 to 140 C for 4 to 5 hours, or a combination thereof.

At block 1240, the method 1200 may include forming an electrode layer over the piezoelectric layer, the electrode layer including one or more acoustic transmitter elements configured to transmit one or more acoustic signals. In some embodiments, the forming of the electrode layer includes performing a sputtering operation.

In some embodiments, the method 1200 may further include, prior to the disposing of the copolymer material, performing one or more cleaning processes on the obtained TFT device. In some implementations, the one or more cleaning processes may include a wet clean, a plasma treatment, or a combination thereof.

In some embodiments, the flexible acoustic sensing apparatus may be coupled with a control system, the control system configured to: control the one or more acoustic transmitter elements to transmit the one or more acoustic signals toward a target object; receive one or more reflected acoustic signals from the target object; and perform an operation based on the received one or more reflected acoustic signals. In some cases, the target object may include a finger of a user; the one or more reflected acoustic signals may include ultrasonic waves corresponding to fingerprint data; and the operation may include a biometric authentication process for the user (e.g., by comparing the fingerprint data to stored fingerprint data).

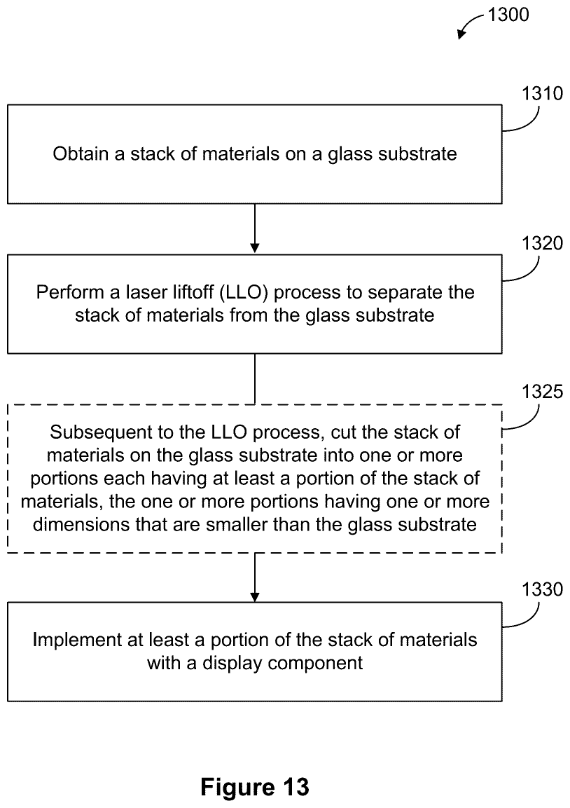

FIG. 13 a flow diagram of another example method 1300 for fabrication of a flexible acoustic sensing apparatus, according to some embodiments. Structure for performing the functionality illustrated in one or more of the blocks shown in FIG. 13 may be performed by hardware and/or software components, such as a control system, of an apparatus or system. Examples of such apparatus or system may include a semiconductor fabrication apparatus or system, or one or more components thereof, e.g., a process chamber or a process station, precursor reactant gas line(s) and inlet(s), radio frequency (RF) power source (e.g., to generate plasma). Such apparatus or system may be communicatively coupled with the control system (including one or more processors), a memory, and/or a computer-readable apparatus including a storage medium storing computer-readable and/or computer-executable instructions that are configured to, when executed by the control system, cause the control system, the one or more processors, or the apparatus or system to perform operations represented by blocks below. Other example components are mentioned elsewhere herein, e.g., a nozzle, a laser.

The method outlined in FIG. 13 may include more or fewer blocks than indicated. Moreover, the blocks of methods disclosed herein are not necessarily performed in the order indicated. In some instances, one or more of the blocks shown in FIG. 13 may be performed concurrently.

At block 1310, the method 1300 may include obtaining a stack of materials on a glass substrate. In some embodiments, the stack of materials may be formed to include a thin-film transistor (TFT) component or device having a flexible substrate; a piezoelectric component or layer on the TFT component; and an electrode component or layer on the piezoelectric component or layer. In some implementations, the piezoelectric component or layer may be configured to, responsive to receipt of an acoustic signal, provide an electrical signal to one or more receiver elements having associated circuitry on the TFT component. In some implementations, the electrode component or layer may include one or more acoustic transmitter elements configured to transmit one or more acoustic signals.

In some implementations, the flexible substrate may include polyimide, and the electrode component or layer may include a layer of conductive silver ink. In some implementations, the method 1300 may further include applying a non-conductive ink on the layer of conductive silver ink.

At block 1320, the method 1300 may include performing a laser liftoff (LLO) process to separate the stack of materials from the glass substrate.

Characteristic of subplate-level LLO, in some implementations, the method 1300 may further include applying a first protective layer over the electrode component or layer prior to the performing of the LLO. In some configurations, the first protective layer may include a polymer, such as polyethylene terephthalate (PET), polyurethane rubber, or thermoplastic polyurethane (TPU). In some implementations, the method 1300 may further include applying a second protective layer to an exposed surface of the TFT device subsequent to the performing of the LLO; and attaching at least the portion of the stack of materials to a flexible printed circuit (FPC) subsequent to the applying of the second protective layer.

In some embodiments, at block 1325, the method 1300 may include, subsequent to the LLO process, cutting the stack of materials on the glass substrate into one or more portions (e.g., at least one chip or die) each having at least a portion of the stack of materials, the one or more portions having one or more dimensions that are smaller than the glass substrate.

At block 1330, the method 1300 may include implementing at least a portion of the stack of materials with a display component.

In some embodiments, the flexible acoustic sensing apparatus may be coupled with a control system. In some implementations, the control system may be configured to: control the one or more acoustic transmitter elements to transmit the one or more acoustic signals toward a target object; receive one or more reflected acoustic signals corresponding to fingerprint data from the target object; and perform an operation based on the received one or more reflected acoustic signals.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that may be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those having ordinary skill in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein, if at all, to mean “serving as an example, instance, or illustration.” Any implementation described herein as “exemplary” is not necessarily to be construed as preferred or advantageous over other implementations. Moreover, the following claims are not intended to be limited to the implementations shown herein, but are to be accorded the widest scope consistent with this disclosure, the principles and the novel features disclosed herein.

It will be understood that unless features in any of the particular described implementations are expressly identified as incompatible with one another or the surrounding context implies that they are mutually exclusive and not readily combinable in a complementary and/or supportive sense, the totality of this disclosure contemplates and envisions that specific features of those complementary implementations may be selectively combined to provide one or more comprehensive, but slightly different, technical solutions. It will therefore be further appreciated that the above description has been given by way of example only and that modifications in detail may be made within the scope of this disclosure.

Additionally, certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. Moreover, various ones of the described and illustrated operations can itself include and collectively refer to a number of sub-operations. For example, each of the operations described above can itself involve the execution of a process or algorithm. Furthermore, various ones of the described and illustrated operations can be combined or performed in parallel in some implementations. Similarly, the separation of various system components in the implementations described above should not be understood as requiring such separation in all implementations. As such, other implementations are within the scope of the following claims. In some cases, the actions recited in the claims can be performed in a different order and still achieve desirable results.

Implementation examples are described in the following numbered clauses:
Clause 1: A method for fabrication of a flexible acoustic sensing apparatus, the method comprising: obtaining a thin-film transistor (TFT) device having a flexible substrate; disposing a copolymer material onto the TFT device having the flexible substrate; performing a poling process on the coated copolymer material to produce a piezoelectric layer, wherein the piezoelectric layer is configured to, responsive to receipt of an acoustic signal, provide an electrical signal to one or more receiver elements having associated circuitry of the TFT device; and forming an electrode layer over the piezoelectric layer, the electrode layer comprising one or more acoustic transmitter elements configured to transmit one or more acoustic signals.
Clause 2: The method of clause 1, wherein the flexible substrate comprises polyimide.
Clause 3: The method of clause 1, wherein: the TFT device having the flexible substrate is disposed on a glass substrate; and the method further comprises, subsequent to the forming of the electrode layer over the piezoelectric layer, performing a laser liftoff (LLO) to separate the glass substrate from the TFT device having the flexible substrate.
Clause 4: The method of clause 3, further comprising applying a first protective layer over the electrode layer prior to the performing of the LLO, the first protective layer comprising polyethylene terephthalate (PET), polyurethane rubber, or thermoplastic polyurethane (TPU).
Clause 5: The method of clause 4, further comprising applying a second protective layer to an exposed surface of the TFT device created by the LLO, the second protective layer comprising polyethylene terephthalate (PET), polyurethane rubber, or thermoplastic polyurethane (TPU).
Clause 6: The method of clause 1, wherein the poling process comprises a corona poling process in which a corona voltage and a grid voltage each exceeding 4 kilovolts (kV) are applied for a poling time of 30 minutes at a temperature between 25 and 80 C in dry air.
Clause 7: The method of clause 1, further comprising, subsequent to the disposing of the copolymer material and prior to the poling process, performing an annealing process on the copolymer material.
Clause 8: The method of clause 7, wherein the annealing process comprises a soft bake at 70 C for 1 hour under a pressure of 0.001 millibar (mbar) or less, a crystallization process at 135 to 140 C for 4 to 5 hours, or a combination thereof.
Clause 9: The method of clause 1, wherein the obtaining of the TFT device further comprises adding a buffer layer during fabrication of the TFT device.
Clause 10: The method of clause 9, wherein the buffer layer comprises silicon dioxide (SiO2) to increase thermal resistance and mechanical resistance of the obtained TFT device.
Clause 11: The method of clause 1, wherein the disposing of the copolymer material comprises spray coating the copolymer material using a nozzle until a copolymer layer having a thickness of about 5-30 μm is coated on the TFT device.
Clause 12: The method of clause 1, wherein the disposing of the copolymer material comprises laminating a copolymer layer on the TFT device.
Clause 13: The method of clause 1, wherein the electrode layer comprises a layer of conductive silver ink.
Clause 14: The method of clause 1, further comprising, prior to the disposing of the copolymer material, performing one or more cleaning processes on the obtained TFT device.
Clause 15: The method of clause 14, wherein the one or more cleaning processes comprise a wet clean, a plasma treatment, or a combination thereof.
Clause 16: The method of clause 1, wherein the forming of the electrode layer comprises performing a sputtering operation.
Clause 17: The method of clause 1, further comprising laminating the flexible acoustic sensing apparatus to a display apparatus.
Clause 18: The method of clause 1, further comprising embedding the flexible acoustic sensing apparatus inside a display apparatus.
Clause 19: The method of clause 1, wherein the flexible acoustic sensing apparatus coupled with a control system, the control system configured to: control the one or more acoustic transmitter elements to transmit the one or more acoustic signals toward a target object; receive one or more reflected acoustic signals from the target object; and perform an operation based on the received one or more reflected acoustic signals.
Clause 20: The method of clause 16, wherein: the target object comprises a finger of a user; the one or more reflected acoustic signals comprise ultrasonic waves corresponding to fingerprint data; and the operation comprises a biometric authentication process for the user.
Clause 21: A method for fabrication of a flexible acoustic sensing apparatus, the method comprising: forming a stack of materials on a glass wafer, the stack of materials comprising: a thin-film transistor (TFT) device having a flexible substrate; a piezoelectric layer on the TFT device, the piezoelectric layer configured to, responsive to receipt of an acoustic signal, provide an electrical signal to one or more receiver elements having associated circuitry on the TFT device; and an electrode layer on the piezoelectric layer, the electrode layer comprising one or more acoustic transmitter elements configured to transmit one or more acoustic signals; performing a laser liftoff (LLO) process to separate the stack of materials from the glass wafer; subsequent to the LLO process, cutting the stack of materials on the glass wafer into at least one chip having at least a portion of the stack of materials, the at least one chip having one or more dimensions that are smaller than the glass wafer; and implementing the at least one chip having at least the portion of the stack of materials with a display component.
Clause 22: The method of clause 21, wherein: the flexible substrate comprises polyimide, and the electrode layer comprises a layer of conductive silver ink; and the method further comprises applying a non-conductive ink on the layer of conductive silver ink.
Clause 23: The method of clause 21, further comprising applying a first protective layer over the electrode layer prior to the performing of the LLO, the first protective layer comprising polyethylene terephthalate (PET), polyurethane rubber, or thermoplastic polyurethane (TPU).
Clause 24: The method of clause 21, further comprising: applying a second protective layer to an exposed surface of the TFT device subsequent to the performing of the LLO; and attaching at least the portion of the stack of materials to a flexible printed circuit (FPC) subsequent to the applying of the second protective layer.
Clause 25: The method of clause 21, wherein the flexible acoustic sensing apparatus is coupled with a control system, the control system configured to: control the one or more acoustic transmitter elements to transmit the one or more acoustic signals toward a target object; receive one or more reflected acoustic signals corresponding to fingerprint data from the target object; and perform an operation based on the received one or more reflected acoustic signals.
Clause 26: A method for fabrication of a flexible acoustic sensing apparatus, the method comprising: obtaining a stack of materials on a glass wafer, the stack of materials comprising: a thin-film transistor (TFT) component having a flexible substrate; a piezoelectric component on the TFT component, the piezoelectric component configured to, responsive to receipt of an acoustic signal, provide an electrical signal to one or more receiver elements having associated circuitry on the TFT component; and an electrode component on the piezoelectric component, the electrode component comprising one or more acoustic transmitter elements configured to transmit one or more acoustic signals; performing a laser liftoff (LLO) process to separate the stack of materials from the glass wafer; and implementing at least a portion of the stack of materials with a display component.
Clause 27: The method of clause 26, wherein: the flexible substrate comprises polyimide, and the electrode component comprises a layer of conductive silver ink; and the method further comprises applying a non-conductive ink on the layer of conductive silver ink.
Clause 28: The method of clause 26, further comprising applying a first protective layer over the electrode component prior to the performing of the LLO, the first protective layer comprising polyethylene terephthalate (PET), polyurethane rubber, or thermoplastic polyurethane (TPU).
Clause 29: The method of clause 26, further comprising: applying a second protective layer to an exposed surface of the TFT component subsequent to the performing of the LLO; and attaching at least the portion of the stack of materials to a flexible printed circuit (FPC) subsequent to the applying of the second protective layer.
Clause 30: The method of clause 26, wherein the flexible acoustic sensing apparatus is coupled with a control system, the control system configured to: control the one or more acoustic transmitter elements to transmit the one or more acoustic signals toward a target object; receive one or more reflected acoustic signals corresponding to fingerprint data from the target object; and perform an operation based on the received one or more reflected acoustic signals.

What is claimed:

1. A method for fabrication of a flexible acoustic sensing apparatus, the method comprising:
obtaining a thin-film transistor (TFT) device having a flexible substrate;
disposing a copolymer material onto the TFT device having the flexible substrate;
performing a poling process on the copolymer material to produce a piezoelectric layer, wherein the piezoelectric layer is configured to, responsive to receipt of an acoustic signal, provide an electrical signal to one or more receiver elements having associated circuitry of the TFT device; and
forming an electrode layer over the piezoelectric layer, the electrode layer comprising one or more acoustic transmitter elements configured to transmit one or more acoustic signals.

2. The method of claim 1, wherein the flexible substrate comprises polyimide.

3. The method of claim 1, wherein:
the TFT device having the flexible substrate is disposed on a glass substrate; and
the method further comprises, subsequent to the forming of the electrode layer over the piezoelectric layer, performing a laser liftoff (LLO) to separate the glass substrate from the TFT device having the flexible substrate.

4. The method of claim 3, further comprising applying a first protective layer over the electrode layer prior to the performing of the LLO, the first protective layer comprising polyethylene terephthalate (PET), polyurethane rubber, or thermoplastic polyurethane (TPU).

5. The method of claim 4, further comprising applying a second protective layer to an exposed surface of the TFT device created by the LLO, the second protective layer comprising PET, polyurethane rubber, or TPU.

6. The method of claim 1, wherein the poling process comprises a corona poling process in which a corona voltage and a grid voltage each exceeding 4 kilovolts (kV) are applied for a poling time of 30 minutes at a temperature between 25 and 80 C in dry air.

7. The method of claim 1, further comprising, subsequent to the disposing of the copolymer material and prior to the poling process, performing an annealing process on the copolymer material.

8. The method of claim 7, wherein the annealing process comprises a soft bake at 70 C for 1 hour under a pressure of 0.001 millibar (mbar) or less, a crystallization process at 135 to 140 C for 4 to 5 hours, or a combination thereof.

9. The method of claim 1, wherein the obtaining of the TFT device comprises adding a buffer layer during fabrication of the TFT device.

10. The method of claim 9, wherein the buffer layer comprises silicon dioxide (SiO₂) or silicon nitride (SiN) to increase thermal resistance and mechanical resistance of the obtained TFT device.

11. The method of claim 1, wherein the disposing of the copolymer material comprises spray coating the copolymer material using a nozzle until a copolymer layer having a thickness of about 5-30 μm is coated on the TFT device.

12. The method of claim 1, wherein the disposing of the copolymer material comprises laminating a copolymer layer on the TFT device.

13. The method of claim 1, wherein the electrode layer comprises a layer of conductive silver ink.

14. The method of claim 1, further comprising, prior to the disposing of the copolymer material, performing one or more cleaning processes on the obtained TFT device.

15. The method of claim 14, wherein the one or more cleaning processes comprise a wet clean, a plasma treatment, or a combination thereof.

16. The method of claim 1, wherein the forming of the electrode layer comprises performing a sputtering operation.

17. The method of claim 1, further comprising laminating the flexible acoustic sensing apparatus to a display apparatus.

18. The method of claim 1, further comprising embedding the flexible acoustic sensing apparatus inside a display apparatus.

19. The method of claim 1, wherein the flexible acoustic sensing apparatus is coupled with a control system, the control system configured to:
control the one or more acoustic transmitter elements to transmit the one or more acoustic signals toward a target object;
receive one or more reflected acoustic signals from the target object; and
perform an operation based on the received one or more reflected acoustic signals.

20. The method of claim 19, wherein:
the target object comprises a finger of a user;
the one or more reflected acoustic signals comprise ultrasonic waves corresponding to fingerprint data; and
the operation comprises a biometric authentication process for the user.

21. A method for fabrication of a flexible acoustic sensing apparatus, the method comprising:
forming a stack of materials on a glass wafer, the stack of materials comprising:
a thin-film transistor (TFT) device having a flexible substrate;
a piezoelectric layer on the TFT device, the piezoelectric layer configured to, responsive to receipt of an acoustic signal, provide an electrical signal to one or more receiver elements having associated circuitry on the TFT device; and
an electrode layer on the piezoelectric layer, the electrode layer comprising one or more acoustic transmitter elements configured to transmit one or more acoustic signals;
performing a laser liftoff (LLO) process to separate the stack of materials from the glass wafer;
subsequent to the LLO process, cutting the stack of materials on the glass wafer into at least one chip having at least a portion of the stack of materials, the at least one chip having one or more dimensions that are smaller than the glass wafer; and
implementing the at least one chip having at least the portion of the stack of materials with a display component.

22. The method of claim 21, wherein:
the flexible substrate comprises polyimide, and the electrode layer comprises a layer of conductive silver ink; and
the method further comprises applying a non-conductive ink on the layer of conductive silver ink.

23. The method of claim 21, further comprising applying a first protective layer over the electrode layer prior to the performing of the LLO, the first protective layer comprising polyethylene terephthalate (PET), polyurethane rubber, or thermoplastic polyurethane (TPU).

24. The method of claim 21, further comprising:
applying a second protective layer to an exposed surface of the TFT device subsequent to the performing of the LLO; and
attaching at least the portion of the stack of materials to a flexible printed circuit (FPC) subsequent to the applying of the second protective layer.

25. The method of claim 21, wherein the flexible acoustic sensing apparatus is coupled with a control system, the control system configured to:
control the one or more acoustic transmitter elements to transmit the one or more acoustic signals toward a target object;
receive one or more reflected acoustic signals corresponding to fingerprint data from the target object; and perform an operation based on the received one or more reflected acoustic signals.

26. A method for fabrication of a flexible acoustic sensing apparatus, the method comprising:
obtaining a stack of materials on a glass wafer, the stack of materials comprising:
a thin-film transistor (TFT) component having a flexible substrate;
a piezoelectric component on the TFT component, the piezoelectric component configured to, responsive to receipt of an acoustic signal, provide an electrical signal to one or more receiver elements having associated circuitry on the TFT component; and
an electrode component on the piezoelectric component, the electrode component comprising one or more acoustic transmitter elements configured to transmit one or more acoustic signals;
performing a laser liftoff (LLO) process to separate the stack of materials from the glass wafer; and
implementing at least a portion of the stack of materials with a display component.

27. The method of claim 26, wherein:
the flexible substrate comprises polyimide, and the electrode component comprises a layer of conductive silver ink; and
the method further comprises applying a non-conductive ink on the layer of conductive silver ink.

28. The method of claim 26, further comprising applying a first protective layer over the electrode component prior to the performing of the LLO, the first protective layer comprising polyethylene terephthalate (PET), polyurethane rubber, or thermoplastic polyurethane (TPU).

29. The method of claim 26, further comprising:
applying a second protective layer to an exposed surface of the TFT component subsequent to the performing of the LLO; and
attaching at least the portion of the stack of materials to a flexible printed circuit (FPC) subsequent to the applying of the second protective layer.

30. The method of claim 26, wherein the flexible acoustic sensing apparatus is coupled with a control system, the control system configured to:
control the one or more acoustic transmitter elements to transmit the one or more acoustic signals toward a target object;
receive one or more reflected acoustic signals corresponding to fingerprint data from the target object; and
perform an operation based on the received one or more reflected acoustic signals.
